(19) United States
(12) Patent Application Publication
(10) Pub. No.: US 2010/0274691 A1
(43) Pub. Date: Oct. 28, 2010

(54) MULTI ALERTS BASED SYSTEM

(76) Inventors: Ayman Hammad, Pleasanton, CA (US); Mark Carlson, Half Moon Bay, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/769,137

(22) Filed: Apr. 28, 2010

Related U.S. Application Data
(60) Provisional application No. 61/237,806, filed on Aug. 28, 2009.
(60) Provisional application No. 61/173,371, filed on Apr. 28, 2009.

(51) Int. Cl. G06Q 20/00; G06Q 10/00; G06Q 40/00; G06F 15/16

(52) U.S. Cl. 705/30; 709/206

(57) ABSTRACT

Systems and methods for defining, observing and detecting triggering user account events that initiate a user account alert message to be sent to one or more users are disclosed. Location and merchant, transaction result, device and, usage history/trend types of user account alerts and trigger criteria can be defined or selected by users, issuers were notification alert engines. Alternatively, user account alerts and trigger criteria can be defined by analyzing previously observed user account events, such as credit card transactions, to determine user profiles and user account usage trends, i.e. credit card spending patterns, as baselines for comparing newly observed user account events. If information associated with the newly observed user account events match any of the trigger criteria or are inconsistent with the determined user profile or user account usage trends, then user account alerts can be sent to one or more users.

### CROSS-REFERENCES TO RELATED APPLICATIONS

This non-provisional patent application is based on and claims priority to U.S. Provisional Patent Application No. 61/173,371, entitled Alerts Based System and Method, filed on Apr. 28, 2009, and U.S. Provisional Patent Application No. 61/237,806, entitled Variable Audio Alert, filed on Aug. 28, 2009. Each of these provisional applications is incorporated by reference herein in its entirety for all purposes.

### BACKGROUND

Transaction alerts such as e-mails can be sent to mobile phones when certain types of transaction are conducted. In a typical situation, a person may conduct a transaction at a merchant using a credit card. After the person swipes his card, the person may receive a notification on his or her mobile phone indicating that a transaction has been conducted.

Although such transactions alerts are effective, improvements could be made. For example, in some instances, consumers may receive too many alert messages. Consumers may only want to receive alerts in certain types of situation. In other cases, other consumers may not wish to take the time to tell a payment processor about what types of transactions are potentially fraudulent, since such consumers may not be in the best positions to determine whether or not transactions are potentially fraudulent.

Embodiments of the invention address these and other problems, individually and collectively.

### BRIEF SUMMARY

Embodiments of the invention are directed to methods, computer readable medium, servers and systems including transaction notifications.

In one embodiment, a method for detecting triggering events for initiating user account alert messages using a notification server is disclosed. The method includes observing a user account event at the notification server and identifying a user account associated with the user account event. Data representing the observed user account event is then compared with a plurality of prior user account events associated with the identified user account and then determining if the user account event is a triggering event based on the comparison. Other related embodiments are directed toward a method for detecting triggering user account events by determining an alert threshold value for a user event type associated with the observed user account event based on a history of prior user account events and comparing a value associated with the observed user account event with the alert threshold value.

Various other embodiments of the present invention are directed to methods for detecting triggering events for initiating user account alert messages using a notification server. The methods include observing a user account event at the notification server and identifying a user account associated with the user account event. Data representing the observed user account event is then compared with a plurality of predefined triggering user account events associated with the identified user account or a user account issuer. Based on the comparison of the observed user account events and the plurality of predefined triggering user account events, it can be determined if the user account event is a triggering event. The plurality of predefined triggering user account events can include a location and merchant type trigger criteria, or usage history/trend type trigger criteria, or device type trigger criteria, or transaction result type trigger criteria.

Another embodiment of the invention is directed to a method comprising sending by an access device an authorization request message to an issuer via a payment processing network comprising a server computer, wherein the server computer (i) observes a user account event at the notification server after receiving the authorization request message, (ii) identifies a user account associated with the user account event using the notification server, (iii) compares the observed user account event with a plurality of prior user account events associated with the identified user account using the notification server; (iv) and determines if the user account event is a triggering event based on the comparison of the observed user account event and the plurality of prior user account events; and receiving an authorization request message from the payment processing network.

Another embodiment of the invention is directed to a method comprising: sending by an access device an authorization request message to an issuer via a payment processing network comprising a server computer, wherein the server computer (i) observes a user account event at the notification server; (ii) identifies a user account associated with the user account event using the notification server, (iii) compares the observed user account event with a plurality of predefined triggering user account events associated with the identified user account or a user account issuer using the notification server, and (iv) determines if the user account event is a triggering event based on the comparison of the observed user account events and the plurality of predefined triggering user account events using the notification server, wherein the plurality of predefined triggering user account events comprise location and merchant type trigger criteria, or usage history/trend type trigger criteria, device type trigger criteria, or transaction result type trigger criteria; and receiving an authorization request message from the payment processing network.

These and other embodiments of the invention are described in further detail below.

### BRIEF DESCRIPTION OF THE DRAWINGS

FIG. 1 is a schematic diagram of a system 100 that can include and be improved by various embodiments of the present invention.

FIG. 2 is schematic of a system and an associated data flow for setting, defining, storing, and detecting user account events and trigger criteria that can be used for sending user and consumer alerts according to various embodiments of the present invention.

FIG. 3 shows various types of user account alerts and trigger criteria and associated data stores according to various embodiments of the present invention.

FIG. 4 shows the data flow and availability of data to an intelligent notification engine according to various embodiments of the present invention.

FIG. 5 is a flow chart of a method for sending user account alert messages based on user account events according to various embodiments of the present invention.

FIGS. 6A and 6B show examples of various types of user account alert messages according to various embodiments of the present invention.

FIG. 7A shows examples of location and merchant type user account alerts and trigger criteria according to various embodiments of the present invention.

FIG. 7B shows a visual representation of an exemplary location and merchant type user account alerts and trigger criteria according to various embodiments of the present invention.

FIG. 7C shows examples of location and merchant type user account alerts and trigger criteria according to various embodiments of the present invention.

FIG. 8 shows examples of transaction result type user account alerts and trigger criteria according to various embodiments of the present invention.

FIG. 9 shows examples of device type user account alerts and trigger criteria according to various embodiments of the present invention

FIG. 10A shows examples of usage history/trend type user account alerts and trigger criteria according to various embodiments of the present invention.

FIG. 10B is a visual representation of usage history/trend type user account alerts and trigger criteria according to various embodiments of the present invention.

FIG. 11 is a Venn-Diagram representation of composite user account alerts and criteria according to various embodiments of the present invention.

FIG. 12 is a high-level block diagram of a computer system that may be used to implement various embodiments of the present invention.

### DETAILED DESCRIPTION

Embodiments of the present invention are directed toward systems, methods, user account alerts and trigger criteria for intelligently notifying a user about user account events involving his or her user accounts. User account alert messages can be sent to a user when a triggering or otherwise qualified user account event has been detected. In some embodiments, the triggering user account event is referred to as a trigger or triggering event. For example, a user can be notified by a text message sent to his mobile phone anytime his credit card transaction is used in a credit card transaction that deviates from his or her normal usage of the credit card.

Many different types of user account events can be observed, however, only a select number of the user accounts will be classified as qualified user account events or triggering events that will cause a user account alert message to be generated and sent to a user. According to various embodiments of the present invention, user account events, triggers and triggering events can be classified into at least four categories.

For example, user account events, user account alerts and triggering events can be classified or defined under one of the four following general types: “Location and Merchant Type,” “Transaction Result Type” “Device Type,” and “Usage History/Trend Type.” Various other miscellaneous user account events, user account alerts and triggering events can be used implemented with the systems and methods described herein. The bulk of the resulting user account alert messages, or more simply, user account alerts, can be discussed in reference to one or more of the four categories, but on occasion, a user or a user account issuer may find it beneficial to define or specify a triggering event based on user account events that can span multiple categories or the miscellaneous user account events, user account alerts and triggering events that do not readily fit into one of the four categories. Embodiments of the present invention can be applied to many different varieties of user accounts, such as credit and debit card accounts, bank accounts, online merchant accounts. Likewise, the systems in which embodiments of the present invention can be used, include, but are not limited to, credit and debit card payment processing networks, financial clearing house systems and other service providers, such as mobile telephone service providers.

Systems

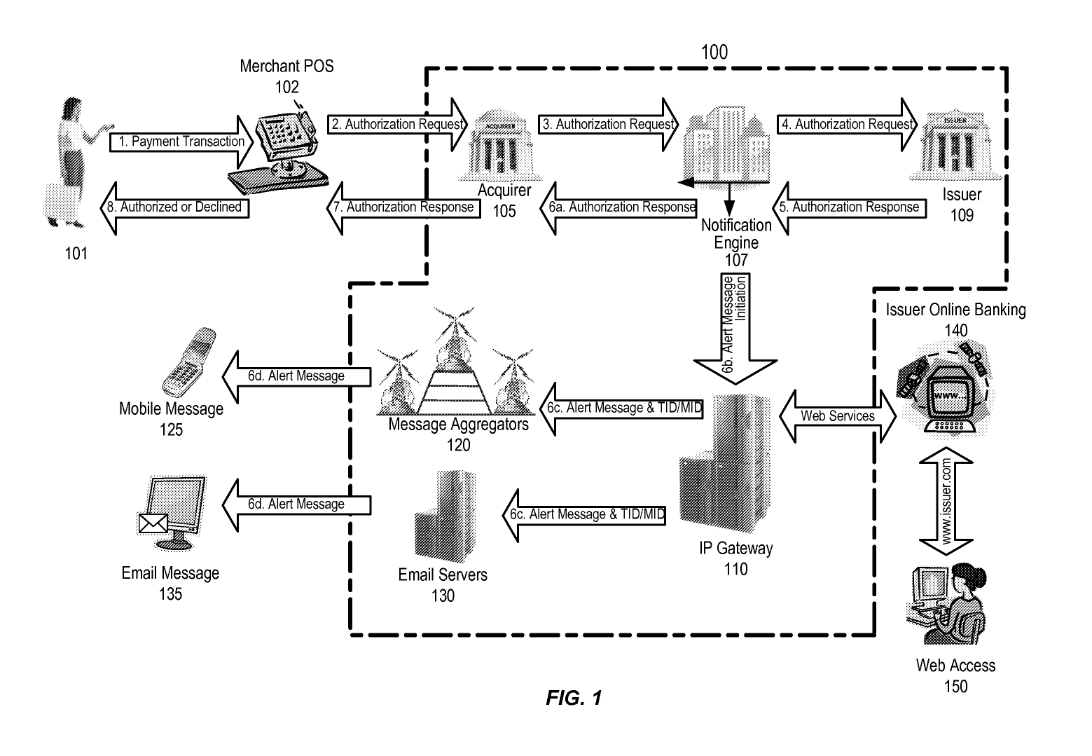

To put various embodiments of the present invention into context, examples of systems in which the various embodiments of user account alerts types can be implemented or utilized are described below. The type and configuration of the specific systems that can implement, and thereby be improved, can depend on the goal, function and use of the systems. The exact specifications and operations of such systems can, of course, vary depending on the utility of the systems. The example of the transaction processing system, with user account alert messaging capability, described in reference to FIG. 1 is intended to be illustrative and should not be construed to limit embodiments of the present invention.

FIG. 1 is a schematic diagram of a system 100, which can include and be improved by various embodiments of the present invention. In some embodiments, system 100 can include a transaction processing system that can use and/or process many forms of portable consumer devices or user tokens, user account number and identifiers to initiate various forms of transactions including, but not limited to, credit card transactions, debit card transactions, mobile telephone initiated transactions such as telephone calls, etc. In other embodiments, users can initiate transactions from a computer either by logging into an authorized website that has the ability to initiate a transaction from particular account, i.e. PayPal™, Google Checkout™ or the like, or by a user entering account information from personal memory for a “token-not-present” transaction. Regardless of the method in which the transaction from a particular account is initiated, various embodiments of the present invention can be used to initiate and send user account alerts to one or more user using various communication channels.

The transaction processing system 100 is an example of a system that can be used to process user transactions and then selectively send user account alert message to one or more users based on information regarding the transactions. User 101 can initiate a transaction or other account activity, such as a credit card transaction in step 1. The transaction can be initiated with a point-of-sale (POS) terminal 102 (POS terminal 102 is an example of an access device), such as a credit card terminal, a computer, a PDA or a mobile telephone. The transaction can be initiated by presenting a portable consumer device to POS terminal. Some POS terminals are configured to read information from the portable consumer device with contact or contactless detection devices. Once the transaction is initiated, an authorization request message can be sent to an entity holding or maintaining the payee or payer user accounts or both, such as an acquirer 105 in step 2. In some embodiments, acquirer 105 can reformat the authorization request message into its own authorization request message and send the message to a notification engine 107 in step 3.

In other embodiments, acquirer 105 can simply pass on the authorization request message it receives from the POS terminal 102 in step 2. Notification engine 107 can pass on the authorization request message from acquirer 105 and POS terminal 102 to issuer 109 for further authorization and authentication in step 4. Once issuer 109 authenticates or authorizes the transaction or other activity requested in the authorization request message, issuer 109 can send an authorization response to the notification engine 107 in step 5. Once notification engine 107 receives the authorization response message, the process can be bifurcated. In step 6a, notification engine 107 can send an authorization response message to acquirer 105, which in turn can provide an authorization response message to the POS terminal 102 in step 7. In step 8, POS terminal 102 can then inform user 101 or a merchant as to whether the requested transaction or other activity is authorized or declined based on the authorization response message.

Meanwhile, in step 6b, notification engine 107 can send a user account alert message initiation request to communication/IP gateway, such as Internet Protocol Gateway (IPG) 110. IPG 110 can use the alert message initiation request from the notification engine 107 to generate an alert message. In some embodiments, IPG 110 can parse out a transaction identifier (TID) or a message identifier (MID) from the alert message initiation request. In other embodiments, IPG 110 can generate a TID or an MID. In either case, IPG 110 can associate each alert message generated with an identifier, such as a TID or an MID.

IPG 110 can then route the alert message and the associated MID to one or more message aggregators 120 or e-mail servers 130 in step 6c. The aggregator to which the alert message and the MID are sent can be based on information contained a user account alert message settings file or in the alert message initiation request and information regarding the message aggregators contained in a routing table. For example, the alert message initiation request, which can be based on a set of user or issuer defined alert message settings, can request that an alert message be sent out via a Simple Message Service (SMS) protocol, Multimedia Messaging Service (MMS) protocol, e-mail or any other messaging service suitable for delivering high-volume messages quickly, efficiently and reliably. Embodiments in which the alert message initiation request specifies a specific delivery protocol, the IPG 110 can refer to a routing table to determine which message aggregator offers the appropriate delivery protocol. Additionally, the IPG 110 can refer to the routing table to determine other pertinent characteristics and information regarding each available message aggregator or mobile carrier 120 or e-mail server 130.

Embodiments in which message aggregators 120 can route user account alert messages to one or more mobile communications service providers, such as mobile telephone service providers, message aggregators 120 can format the messages as one or more text, SMS, MMS or other mobile device compatible messages. At step 6d, the mobile communication carriers can send the mobile compatible messages to one or more mobile devices associated with user 101, a business or a representative of the business. In some embodiments, the mobile device 125 can be a cellular telephone, smart phone, a pager, a two-way-pager or other mobile user device suitable for receiving wireless alert messages.

In other embodiments, IPG 110 can route the user account alert message and MID to e-mail servers 130 in step 6c. In such embodiments, e-mail servers 130 can then route an e-mail message to an e-mail compatible device 135. E-mail compatible device 135 can be a personal computer, a laptop computer, desktop computer, a tablet computer, a smart phone, an e-mail capable mobile telephone or any other e-mail device capable of receiving e-mail.

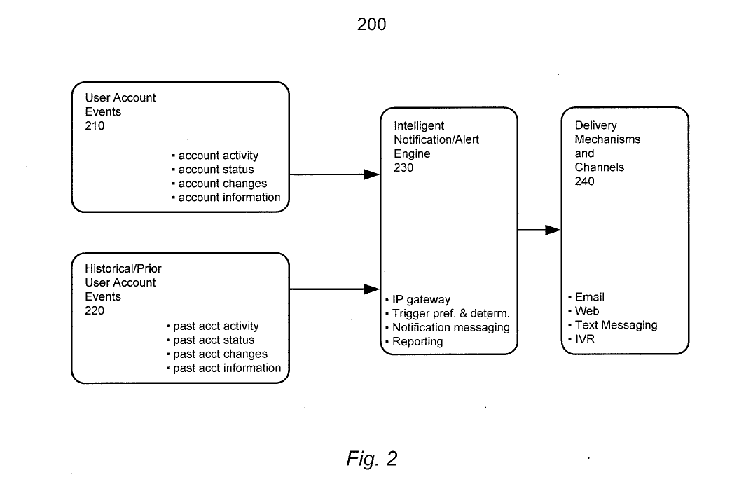

FIG. 2 is a schematic of a system 200 and an associated data flow for setting, defining, storing and detecting user account events and triggers that can be used to initiate and send user and consumer alerts according to various embodiments of the present invention. Notification engine 107 in FIG. 1 can include an intelligent notification/alert engine 230 of FIG. 2. Due to the position of the intelligent notification/alert engine 230 in system 100, it can observe and detect any transaction amongst merchant POS 102, acquirer 105 and issuer 109. Intelligent notification/alert engine 230 can be configured to check and compare all transactions or other user account events it observes, transmits, translates, reformats and/or otherwise has access to.

As used herein, the terms “user accounts” and “user account event” have very broad meaning and can include various types of user accounts and user account activities without deviating from the spirit or scope of the present invention. For example, a user account can include a credit card account, a debit card account, a checking account, a savings account, a mobile telephone account, an e-mail account, an online merchants or payment processing accounts, etc. Similarly, a user account event can include, but is not limited to, financial transactions, user account activities, such as changes to user account information and changes to user account notification preferences and any other activity associated with or involving one or more of the exemplary user accounts listed above.

Intelligent notification/alert engine 230 can request and/or receive information regarding user account events 210 and historical/prior user account events 220. Intelligent notification/alert engine 230 can observe user account events 210 in the form of user account transactions or activity, user account status updates, user account settings or preference changes, or whenever an issuer of the user account would like to push or send information, i.e. advertisements and/or reward opportunities, to one or more of the users. User account events 210 can include all relevant information regarding the information, status, changes and activity associated or involving a particular user account. In other embodiments, user account events 210 can include information regarding multiple accounts for one or more related consumers or users.

Intelligent notification/alert engine 230 can compare information contained in the user account events 210 against various user account alert and trigger criteria and definitions to make a determination as to whether a particular observed user event qualifies as a triggering user account event that will initiate a user account alert message. Triggering user account events, also referred to as triggers, can be defined by an issuer, an acquirer or one or more users associated with the user account. The definition of the triggering user events can be stored within a data store within the intelligent notification/alert engine 230 or they can be stored in a remote data store accessible to the intelligent notification/alert engine 230. In either case, intelligent notification/alert engine 230 can, either in real-time or in a batch basis, compare observed individual user account events 210 for a particular user account with the stored trigger criteria and definitions of the triggering user account events associated with that user account to determine whether to initiate the user account alert message for a particular observed user account event.

When the intelligent notification/alert engine 230 determines that an observed user account event qualifies as a triggering user account event based on a comparison with the definition of a triggering user account event, the user account alert message can then be sent to a user via various delivery mechanisms and channels 240. In such embodiments, each individual user account event has the potential of matching a predefined trigger based solely on information contained in or associated with the user account event. Such user account trigger definitions and criteria are thus treated on a transaction-by-transaction basis and are usually unrelated to prior user account events associated with the particular user account.

In other embodiments, intelligent notification/alert engine 230 can also have access to historical/prior user account events 220. Historical/prior user account events 220 can include stored information or data regarding past user account activity, past user account statuses, past user account changes and past user account information or notifications.

When historical/prior user account events 220 are available to the intelligent notification/alerts engine 230, the historical/prior information regarding the prior user account events 220 can be used to determine whether any particular individual user account event qualifies as a triggering user account event. Intelligent notification/alert engine 230 can analyze the historical/prior user account events 220 related to a particular user account to build one or more profiles and/or usage trends associated with the user or user account. In this way, intelligent notification/alert engine 230 can determine whether an observed user account event is consistent with the user profile and/or the usage trend of a particular associated user or user account. In some embodiments, intelligent notification/alert engine 230 can analyze historical/prior user account events 230 on-the-fly in real-time, while other embodiments, intelligent notification/alert engine 230 can analyze historical/prior user account events 220 during off-peak times or in a batches when system 200 is either less active or otherwise has more bandwidth or processing resources available. Specific exemplary embodiments of historical/prior user account events 220, and the trends and historical profiles that intelligent notification/alert engine 230 can form based on such information, are discussed in detail below in reference to other trigger criteria that can also be used to initiate a user account alert messages. Once a user account alert message initiation request is sent to delivery mechanisms and channels 240, the user account alert message can be sent to one or more users via one or more delivery channels such as, e-mail, the World Wide Web, or text messages to portable consumer devices such as mobile telephones, pagers, etc.

User Account Alert and Trigger Criteria Types

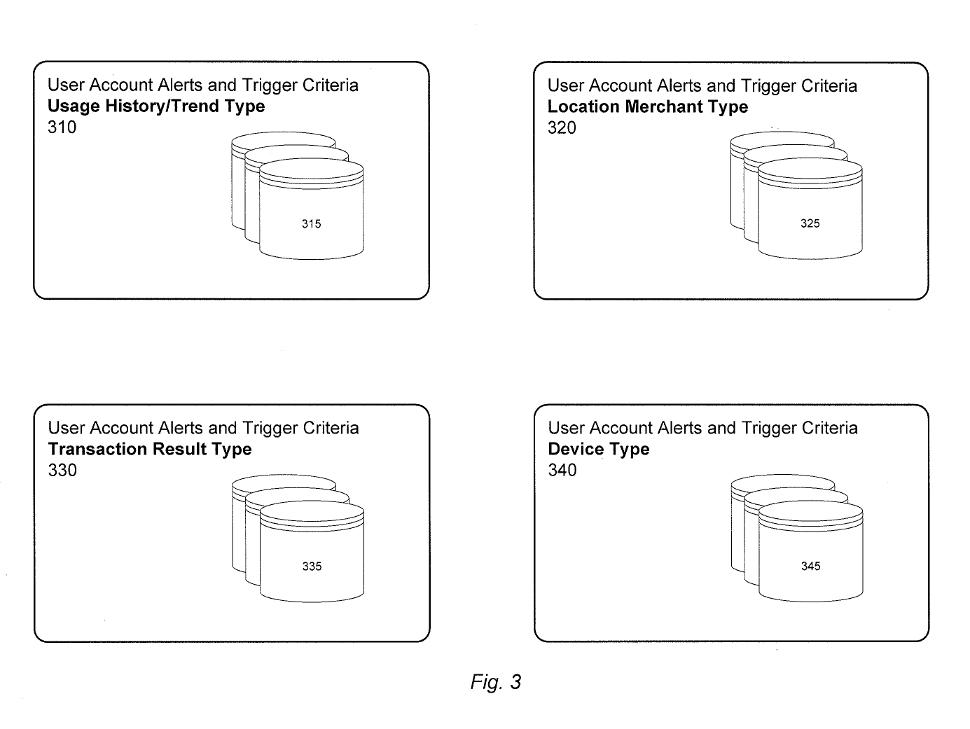

FIG. 3 shows various categories of user account alerts and trigger criteria types and associated data stores according to various embodiments of the present invention. As used herein, the terms “triggering user account event definition types,” “triggering event definition types,” and “trigger criteria types” can be used interchangeably to refer to various categories of predefined triggering event or trend based triggering event criteria or determinations. FIG. 3 shows four specific, though not necessarily mutually exclusive, types of user account alerts and trigger criteria.

Various embodiments include user account alerts and associated trigger criteria such as usage history/trend type 310, location and merchant type 320, transaction result type 330 and device type 340 shown in FIG. 3. Each type of user account alerts and associated criteria can be stored in a memory or data store such as databases 315, 225, 335 and 345, all of which are accessible to intelligent notification/alert engine 230. In some embodiments the databases 315, 325, 335 and 345 are internal to and included in intelligent notification/alert engine 230. In other embodiments, the databases can be remotely accessible to intelligent notification/alert engine 230 via any network suitable for quick and secure data transfers.

Usage history/trend type user account alerts and trigger criteria 310 can include not only definitions but also guidelines and analytical models that intelligent notification/alert engine 230 can use to analyze historical/prior user account events 230 and develop profiles and trends associated with individual users and user accounts as well as user and user account types. Specific exemplary usage history/trend type user account alerts and trigger criteria will be discussed below in more detail.

Location and merchant type user account alerts and or criteria 320 can include definitions of user account alerts and trigger criteria that list specific merchant identifiers, merchant types and merchant locations that can trigger a user account alert message. Additionally, location and merchant type user account alerts and trigger criteria can include definitions of triggering events based on geographic or economic regions. Furthermore, location and merchant type user account alerts and trigger criteria 320 can also include lists of suspicious or potentially fraudulent or criminal individual merchants or point-of-service terminals, that when involved with a particular user account event can trigger a user account alert.

Transaction result type user account alerts and trigger criteria 330 can include definitions of trigger criteria that can include a final or intermediate state of a user account event. For example, a user account alert can be triggered by a credit card transaction being denied or declined. Similarly, the user account alert can be triggered by a particular item, product or service being placed in an online shopping basket or included in a particular transaction or user account event. Specifically, such trigger criteria can be based on SKU or UPC identifiers being present, related to or associated with a particular user account event.

Finally, device type user account alerts and trigger criteria 340 can include definitions of trigger criteria that can include notifications of activation/deactivations of new or replacement portable consumer devices. In such embodiments, the portable consumer devices can include tokens, such as credit cards or debit cards, associated with a particular user account. In other embodiments, the portable consumer device can be a mobile telephone or other portable computing device capable of being used to initiate a user account events or receive a user account alert.

Method of Detecting Triggering Events and Initiating User account Alerts

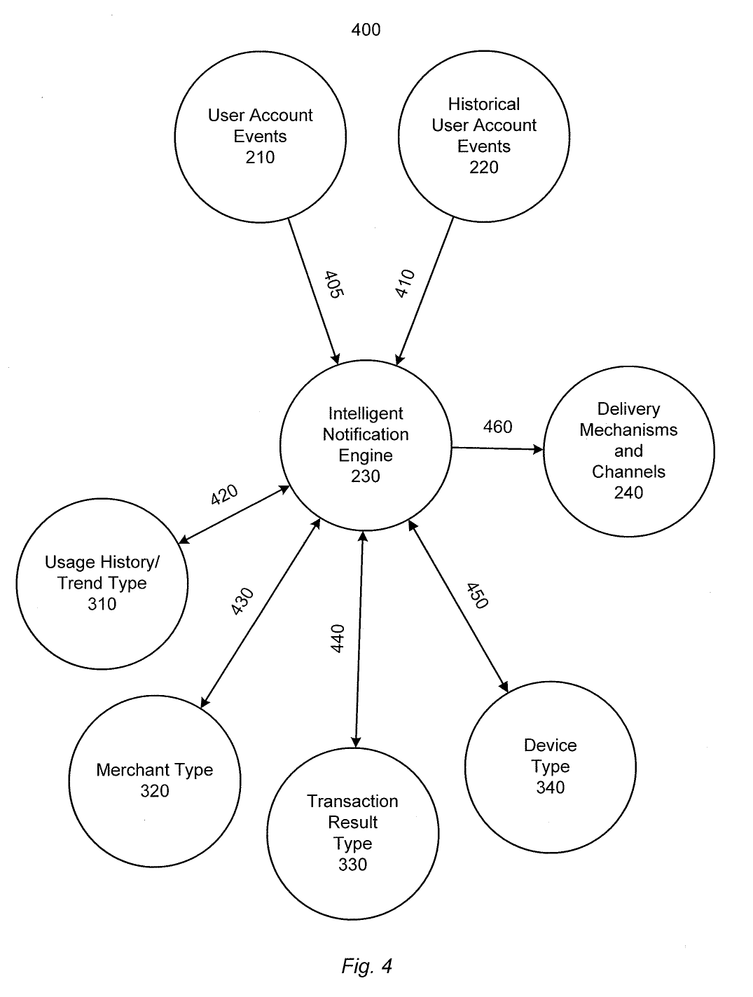

FIG. 4 shows the data to and availability of data to intelligent notification/alert engine 230 according to various embodiments of the present invention. Intelligent notification/alert engine 230 can be implemented as software or a software module in a computer or a server computer in or connected to a system like the one shown in FIG. 1. In alternative embodiments, intelligent notification/alert engine 230 can be implemented as service provided by a third party provider external to a system like system 100 in FIG. 1. In such embodiments, information related to the user account events can be filtered or redacted before being sent to the intelligent notification/alert engine 230 so as to protect users' private information and secure transactions.

As shown, intelligent notification/alert engine 230 can be communicatively connected various systems, server computers, data stores and computer readable media via any wired or wireless network suitable for conducting secure and efficient electronic data communication. In some embodiments, all or some of the electronic communication over connections 405, 410, 420, 430, 440,450 and 460 between intelligent notification/alert engine 230 and the other components shown can be encrypted or otherwise secured to protect the data transmissions from being intercepted by unintended recipients, such as potential fraudsters.

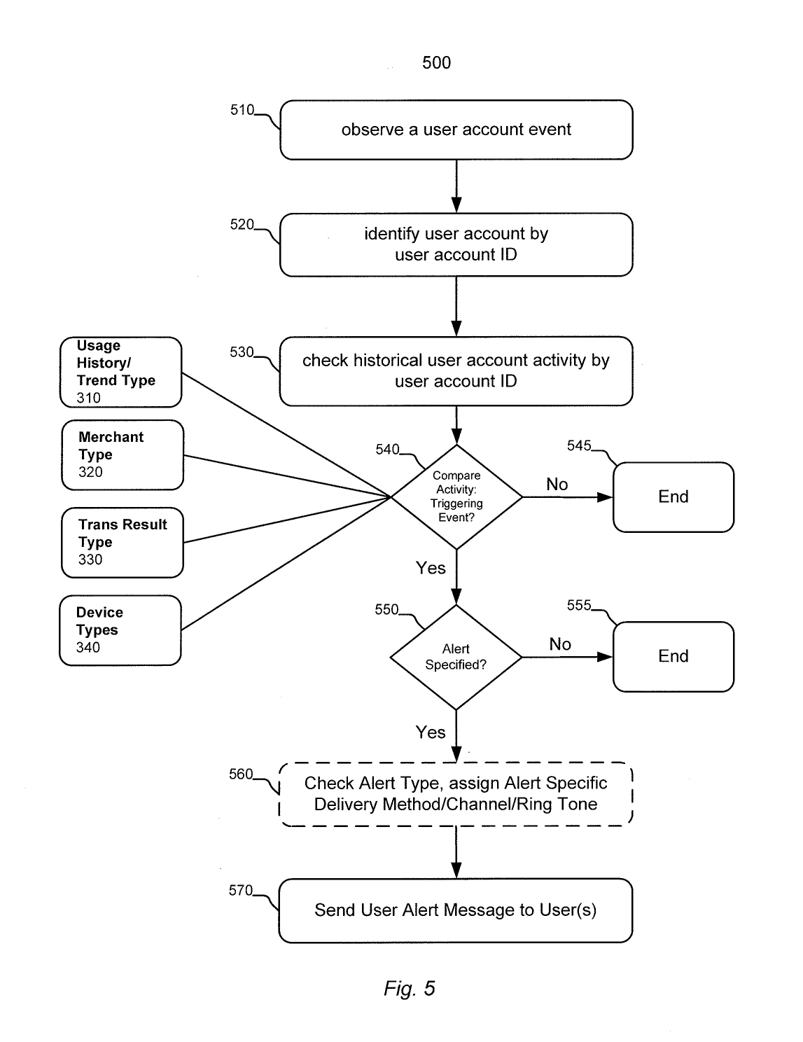

FIG. 5 is a flow chart of a method for sending user account alert messages based on user account events according to various embodiments of the present invention. The flowchart shown in FIG. 5 is discussed with reference to FIG. 4 and the components and the connections shown therein.

In step 510, the intelligent notification/alert engine 230 can observe a user account event. As previously discussed, a user account event can include various user account activities such as financial transactions conducted with a credit or debit card as well as activity involving online or mobile communication device accounts. To observe a user account event, the intelligent notification/alert engine 230 can use information it receives either intentionally or incidentally from merchant POS 102, acquirer 105, issuer 109 or other user account event processing computer or computer server as part of the transaction processing procedure or protocol.

Alternatively, the user account event can be sent to the intelligent notification/alert engine 230 in processes external to the transaction processing procedure. In either case, observing a user account event can include intelligent notification/alert engine 230 receiving and parsing information associated with the observed user account event. Information associated with the user account event can include the date, time, location, origin, amount, personal identification number (PIN), requested or final result and any other information that can be sent along with the user account event for purposes of initiating, routing, processing or reconciling the user account event.

From the information associated with the user account event, the intelligent notification/alert engine 230 can parse a user account identifier associated with the user account event. Using the user account identifier, such as a user account number or user account name, the intelligent notification/alert engine 230 can identify a user account in step 520. Using the user account identifier, the intelligent notification/alert engine 230 can retrieve and check historical or prior user account events or activity in step 530 or a set of predefined user account alerts and trigger criteria. In various embodiments, the prior user account events can be stored and received from data store established and maintained by the transaction processing network 100, like the one shown in FIG. 1. In other embodiments, the prior user account events can be stored in a data store established or maintained by the intelligent notification/alert engine 230.

In step 540, intelligent notification/alert engine 230 can compare the information associated with the observed user account event with one or more types of user account alerts and trigger criteria. In some embodiments, the type of user account alerts and trigger criteria against which the user account event information is compared can be based on which type of user account alerts and trigger criteria are designated for or associated with the user account involved with the observed user account event. In other embodiments, the type of user account alerts and trigger criteria against which the user account event information is compared can be determined in real-time by intelligent notification/alert engine 230. Intelligent notification/alert engine 230 can determine which user account alerts and trigger criteria against which the user account events will be compared based on details of the prior user account events and profiles or trends determined therefrom.

User history/trend type 310, location and merchant type 320, transaction result type 330 and device type 340 user account alerts and trigger criteria can be referenced by intelligent notification/alert engine 230 to compare with the information associated with the observed user account event. The intelligent notification/alert engine 230 can compare the user account event with the various types of user account trigger criteria and, if the observed user account event does not match or otherwise qualifies as a triggering event under one or more of the criteria, then a user account alert message is not initiated nor sent and the process ends at step 545.

However, if the observed user account event matches or otherwise qualifies as a triggering event under one or more of the trigger criteria, then intelligent notification/alert engine 230 can then determine that a triggering event has been observed. Once intelligent notification/alert engine 230 has determined that a triggering event has been observed, then, at step 550, it can check via connections 420, 430, 440, 450 and 460 each or some of the user account alert and trigger criteria types to determine what kind of alert message, if any, should be sent to a user and how. In some embodiments, the intelligent notification/alert engine 230 can determine not to send a user account alert and only log the observed user event for later reference. In such embodiments, in which sending a user account alert is not specified, then no user account alert is sent in step 555 and the process is ended.

When a user account alert is specified, the intelligent notification/alert engine 230 can check the definition for the specified alert type and method or channel of delivery that should be used in step 560. The user account alert message can then be sent via the appropriate delivery method and channel in step 570.

User Account Alert Notification Specific Sounds and Ringtones

In certain embodiments, a user can create and manage audio preferences for the user account alert messages delivered by electronic communication means, such as SMS, MMS and email messages sent to a mobile telephone or other mobile communication device. A user may set up his audio preferences by creating selection criteria associated with each user account alert and trigger criteria type and selecting an audio file for each specific trigger criteria or user account alert. For instance, a user can specify that a ring tone including music from his favorite movie be played whenever his mobile telephone receives a user account alert concerning unlikely activity via an SMS text message. A user may also upload his own personalized audio files to the system. A user may log into an online system associated with this user account alerts or user account to change his audio selection conditions at any time. In other embodiments, the user can change his user account alert audio selection from his portable consumer device using integrated settings in the device itself or using mobile application or “app.”

A specific alert sound can be specified for user account alerts sent via a user's portable communication device such as a user's mobile telephone or pager. Usually, a user's mobile communication device will be set at the device to ring or otherwise alert the user that a new message has been received, i.e. a telephone ring or chime tone. However, the user account alert message sent to the user's device can include a file or a file indicator that would instruct the device to play a specific tone or sound when that specific alert message is received. The tone or sound can be specific to the user account, the type of user account, the user or the user's mobile device. By giving the user an auditory indication as to the content of the user account alert, the user can determine for him or herself the level of attention he or she pays to the newly arrived user account alert. For example, if a triggering event concerning potential fraud involving the user's credit card account is observed by the intelligent notification/alert engine 230, the resulting user account alert can include a specific alarm notification sound such as simulated klaxons.

In some embodiments, if the portable consumer device is a contactless phone, when the consumer waves his contactless phone by a POS terminal or the like, the phone may “beep” or make some other sound. When an alert is received by the phone, it may also “beep” or make the same sound. This can improve upon the consumer experience. Further, in other embodiments, the alert could serve as a receipt, and may also include tax and other information that might be on a typical receipt.

Alert Message Delivery Channels

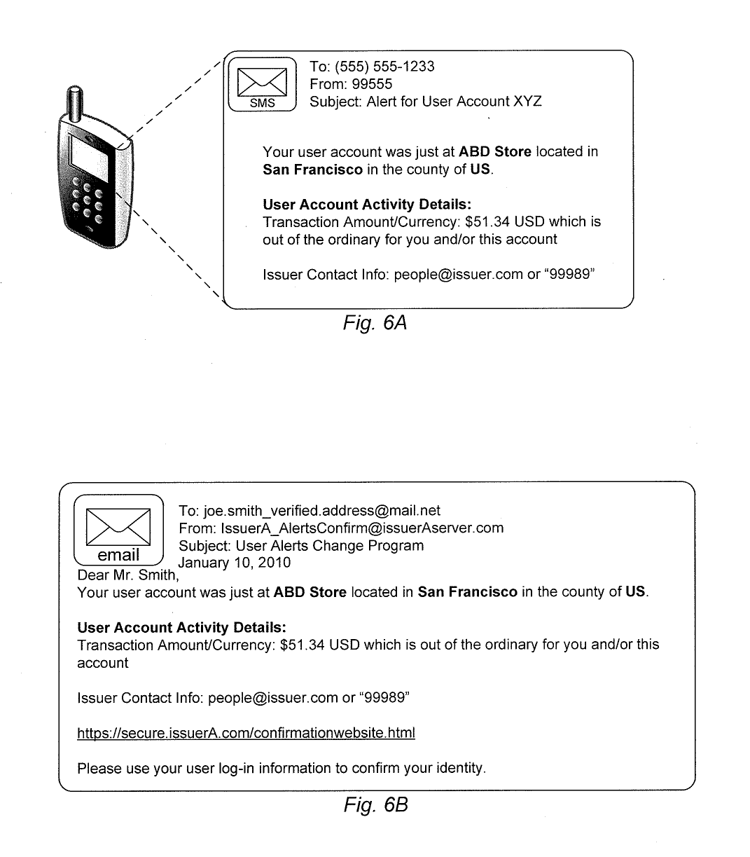

FIGS. 6A and 6B show examples of various types of user account alerts and delivery channels according to various embodiments of the present invention. The method and channel of delivery can depend on numerous factors. The most relevant factor can be user preference. Providing expedient and useful user account alerts is helpful to users when it is delivered by their method of choice. When users know through which channels to expect user account alerts, they can be better prepared to be monitor that channel for timely user accounts alerts. For example, while some users may prefer to receive user account alerts on their mobile telephone via an SMS message, like the one shown in FIG. 6A, to receive non-intrusive, yet timely messages, other users may not have adopted text messaging on their mobile telephones. Such users would not find it helpful, and in some case could actually find it annoying, to receive a user account alert message via SMS messaging if they are not accustomed receiving such messages. In such cases, delivering a user account alert via another channel, such as email, automated telephone call or traditional post, might be preferable.

In certain embodiments of the present invention, user account alert can provide the alert sender information by which the user can identify the sender of the alert message. For example, a user account alert may contain the name and address of the sender. The user account alert may also contain the telephone number of the sender. In certain embodiments, the user account alert may include a logo of the sender, further identifying the sender. An user account alert may also include account information to identify the account involved in the transaction. The account information can clearly identify the account in the alert message, but it may not include the full and complete account number in order to protect the information should the alert message ever get lost or intercepted. For example, an alert message may use a phrase “Credit Card 72” to identify a credit card account that ends in 72. The sender information, the logo, and the account information help the user to recognize the account involved in the transaction quickly.

In certain embodiments of the invention, the main body or content of an alert message comprises various alert information. The alert information can be any information regarding the associated user account event that triggered the user account alert to be sent. Exemplary alert information may read as follows: “There is a charge of $20.00 on your credit card ending with 72 at the Walmart store in Palo Alto, Calif.” Alert information may also include transaction data, such as the value of the transaction, the type of the transaction, the location of the transaction, and the type of the store, etc. Furthermore, the alert information can include brief or detailed analysis of the prior user account events on which the determination to send a usage history/trend type alert was based. For example, the alert information may state, “Your account ending with 72 was recently used to purchase item number SKU1234 at a jewelry type merchant in a zip-code 95014. This account has never been used to purchase SKU1234 at a jewelry type store in the 95014 zip code. Further action is required, otherwise account ending with 72 will be deactivated.”

FIG. 6A shows an example of a user account alert message than can be sent to one or more users' communications devices. The communications devices can include, but are not limited to, cellular or mobile telephones, smart phones, pagers or any other device capable of receiving/sending short alphanumeric text messages such SMS or MMS based text messaging services. Sometimes, communications devices may also be portable consumer devices (e.g., when a phone is both used to receive alert messages and can also be used to make payments). In other embodiments, communications devices can be separate from portable consumer devices (e.g., when a phone is used to receive alert messages and payment cards are used to make payments). As shown, the text message can include address information for the both the sender and the recipient, subject lines information and message content information. The message content information can include details regarding the user account event that triggered the user account alert message and, in some embodiments, information that can be used to respond to the user account alert message.

FIG. 6B shows an example of a user account alert message that can be sent one or more users via email or other internet/intranet based message delivery system, such as instant messaging. The email message can include information similar to the information provided in the text message based user account alert message discussed above in reference to FIG. 6A. Furthermore, the email user account alert message can also include hyperlinks that the receiving user can follow to respond to the user account alert message. In some embodiments, the text message based user account alert messages can also include hyperlink information, as more users, manufacturers and service providers mobile communication devices are currently adopting high-speed wireless internet access for such devices.

In embodiments of the invention, transaction alert messages may be sent substantially contemporaneously with the initiation of a transaction. For example, in some embodiments, the transaction alert messages are sent within about 1, 5, 10, and 20 minutes after a person initiates a transaction with his portable consumer device (e.g., after he swipes his card in a POS terminal at a merchant).

In some embodiments of the invention, the alert engine may also send a user an alert audio file associated with an alert along with the alert message. A mobile communication device receiving the user account alert plays the alert audio file when the alert message is received. The alert engine can send variable alert audio files based on the user account event, such as the value of the transaction, the type of the transaction, the location of the transaction, and the type of the store, etc. For instance, an audio file of loud alarm sound may be sent when the transaction value is over $5000.00. For another example, a different audio file may be played when the

User Account Activity and User Account Events

User account events can include a variety activities involving various user accounts including, but not limited to, credit card transactions, debit card transactions, cash back transactions, declined user account transactions, closed user account notifications, changes of address, new/updated e-mail addresses, requests for clarification regarding profile information, etc. Any user account activity associated with one or more user accounts and observable by the intelligent notification/alert engine 230 or other system can be a user account event.

Whether a user account event initiates a user account alert depends on whether it qualifies as a triggering user account event. If the observed user account event qualifies as a triggering user account event, then intelligent notification/alert engine 230 can initiate a user account alert message request to IPG gateway 110 or can send the user account alert message on its own behalf. Triggering user account events are based on definitions of user account alerts and trigger criteria. User account alerts and trigger criteria can specify parameters, classifications or trends and associated threshold values having predefined acceptable/unacceptable deviations from various information associated with user account events. Information associated with the user account event can include specific information regarding that specific user account event as well as information associated with prior user account events related to the same user or user account. Specific embodiments of user account alerts and trigger criteria will be illustrated using specific examples and associated figures, discussed below.

A triggering user account event can be a declined user account alert triggering event. The declined user account alert triggering event can include or be based on a definition of a deactivated user account. For example, a user account issuer may issue a status or operational update for a particular user account, such as a credit card account, indicating any and all user account events, such as a credit card transaction request message, for the user account should be declined.

Alert Account Alerts and Trigger Criteria Types

Location and Merchant Type

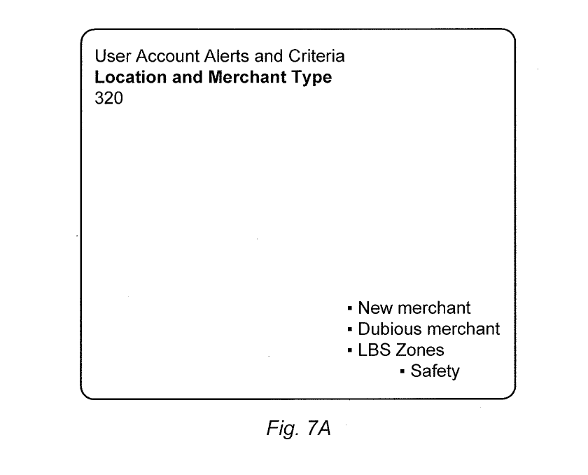

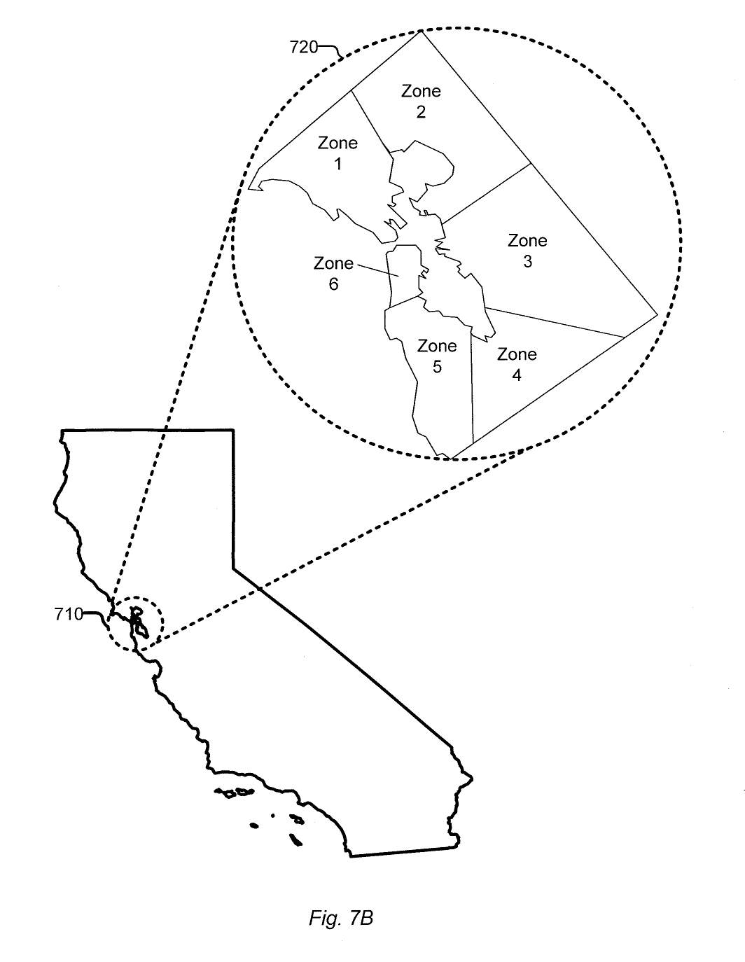

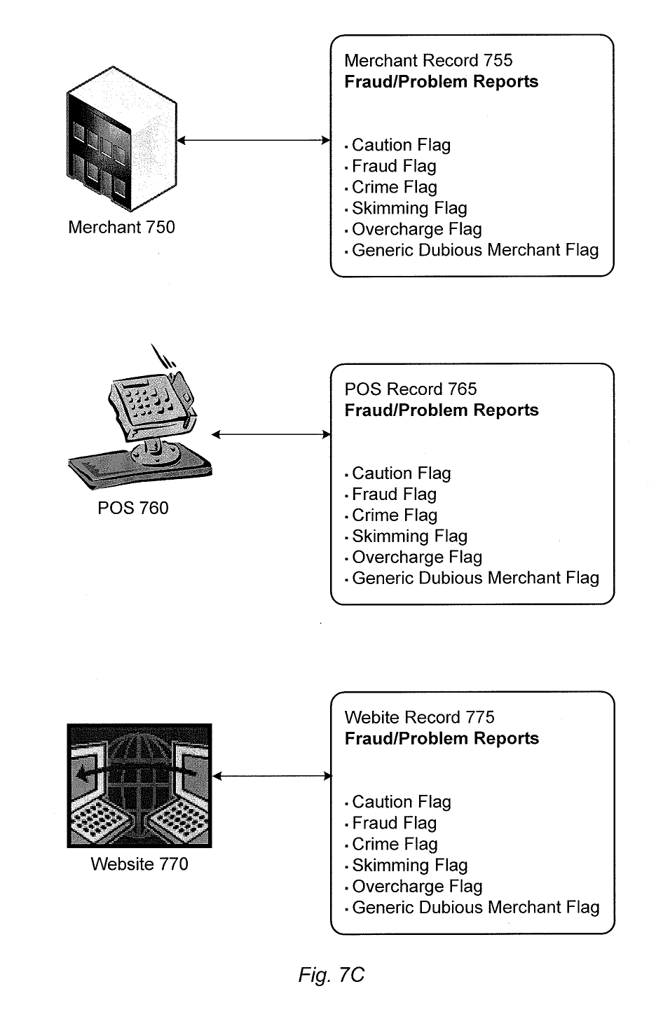

FIG. 7A shows examples of location and merchant type user account alerts and trigger criteria according to various embodiments of the present invention. Location and merchant type user account alerts can be related to the location or identification of a particular merchant associated with a particular user account event. As shown, a user account alert can be sent to one or more users when the intelligent notification/alert engine 230 determines that the user account associated with a particular user account event is being used at particular merchant for the first time. Similarly, the intelligent notification/alert engine 230 can initiate a user account alert message when it determines that the user account event involves a dubious or otherwise suspicious merchant. Lastly, a user account alerts can be sent whenever the intelligent notification/alert engine 230 observes a user account event at any merchant within various location-based services (LBS) zones. The LBS zones can be based on user preferences, law enforcement agencies databases or other third-party databases as determined by the user account user, issuer or intelligent notification/alert engine 230.

Location Based Services

User account alert messages can be sent based on the location of a particular observed user account event by using location based services (LBS) that can be included in various transaction processing networks like the one shown in FIG. 1. In various embodiments, an alert can be sent when a transaction occurs at a destination or location designated as a location of interest.

For example, FIG. 7B shows a specific example of predefined zones within a particular geographic region that can be used by location-based services or intelligent notification/alert engine 230 as trigger criteria for one or more types of user account alerts. The region shown as area 810 is shown magnified in view 820. Within area 810, 6 specific zones are defined and designated as zones 1 through 6. For a user residing in one of the zones, it may be helpful to set up various user account alerts and trigger criteria based on these geographic zones. For example, a user living in zone 6 may define a set of triggering user account events that would send the user a user account alerts whenever one of his or her associated user accounts is observed in a user account event in zones 1 through 5.

In other embodiments, an issuer or the intelligent notification/alert engine 230 can observe the user account usage history or trends based on the geographical zone in which they occur for a particular user or user account. For example, the issuer might observe that a user's credit card is typically used in zone 5 for usual household expenses. Therefore the issuer or the intelligent notification/alert engine 230 can determine that the purchase of a high price home theater system in zone 2, which is separated from zone 5 by a significant geographic distance, is irregular or out of the ordinary. Based in the determination of an irregular credit card transaction in an unexpected zone, the issuer or the notification/alert engine 230 can determine to send the user a user account alert message regarding that particular high priced credit card purchase. Such features and user account alerts and trigger conditions will be discuss in more detail below.

In such embodiments, the location of the consumer can be determined using at least one of the location of the consumer's mobile communication device (e.g., using GPS technology), the location of the merchant (e.g., as determined by a merchant identifier in an authorization request message, and a lookup table in a database accessible to a server computer in a payment processing network), etc. The previously described notification server or other server can use this information to determine whether or not a notification message can be sent.

New Merchant or First-Time Use

In various embodiments, the intelligent notification/alert engine 230 can determine when a particular user account is involved with a user account event at a particular merchant or point-of-sale device for the first time. To do this, the intelligent notification/alert engine 230 can have access to a list or a database of prior user account events associated with the user account. In regards to credit card transactions, an observed credit card transaction can include transaction level information that identifies the merchant or point-of-sale device involved in the credit card transaction.

A triggering user account event can include or be based on a unlikely merchant alert triggering event. The unlikely merchant alert triggering event can include or be based on a list of previously observed merchants. In other embodiments, the unlikely merchant alert triggering event can include or be based on a list of unlikely merchant or merchant types based on a characteristic, such as age, demographic or previously observed indications of acts or interests, of a user associated with the user account.

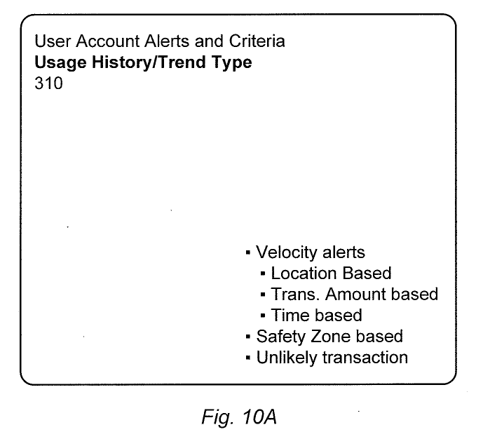

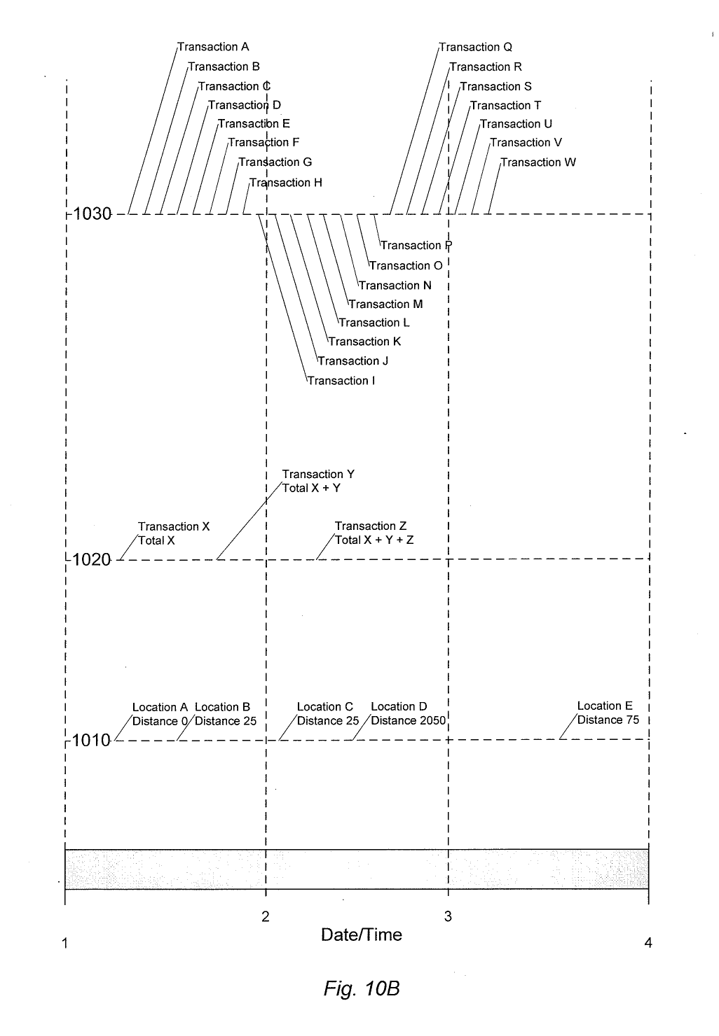

The intelligent notification/alert engine 230 can then check a list of prior credit card transactions or a list of previously observed merchants involved with prior credit card transactions associated with a credit card account. If the merchant from the observed credit card transaction is not found in any of the previously observed merchant lists, then the intelligent notification/alert engine 230 can initiate a user account alert to inform users associated with the credit card account the credit card has been used in a transaction for the first time at particular merchant. New merchant or first-time use alerts can be helpful to the user or the intelligent notification/alert engine 230 to develop a baseline of acceptable merchants and/or locations to be used in real time historical usage or trend based user account alerts will be discussed in more detail below in reference to FIG. 10A.

Dubious or Suspicious Merchants

As previously mentioned, each user account event can include various associated information that the intelligent notification/alert engine 230 can use for comparisons against location and merchant type user account alerts and trigger criteria. If information associated with an observed user account event matches one or more trigger criteria, a user account alert message can be sent. For example, credit card transactions involving credit card account “A” at merchant “X” can include transaction level data specifying the address of the merchant, i.e. by zip code or physical street address, as well as the identity of the merchant, i.e. a merchant identifier ID.

Intelligent notification/alert engine 230 can maintain a list or database of predefined or predetermined acceptable and unacceptable merchant locations or merchant identifiers. In some embodiments, the database of unacceptable or suspicious merchants can be maintained by an outside entity or agency, such a credit bureau or law enforcement database. The list of suspicious merchants can include a list or database of suspicious or potentially fraudulent point-of-sale devices that may or may not be associated with a particular merchant.

In some embodiments, the list of suspicious merchants and point-of-sale devices can include all merchants and point-of-sale devices for a given geographic region. For example, the intelligent notification/alert engine 230, an outside agency, the issuer or user can determine that certain geographic areas are too fraught with fraud and criminal activity to be trusted with any user account events such as credit card transactions. For example, a user may like to define regions or neighborhoods in which all merchants or point-of-sale devices will trigger a user account alert. Zip codes, blocks of addresses and issuer defined zones can be used to identify the groups of merchants and point-of-sale devices that will trigger user account alerts.

As such, if an observed user account event involves one of the merchants or point-of-sale devices in one or more of the suspicious or dubious merchant lists, then the user account alert can be sent to one or more designated users associated with the user account.

In some embodiments, the user account alert message can also be sent to the issuer of the user account. The issuer of user account can then contribute any information it might have regarding the particular merchant in regards to the status of the suspected merchant as a potentially fraudulent or otherwise risky merchant. This information can be used to provide feedback on the suspicious or dubious merchant lists to further strengthen and improve accuracy of the lists.

Safety Zones

The user may indicate to the issuer, intelligent notification/alert system 230 or other suitable entity that the user wishes to be notified every time a transaction, such as a purchase using a portable consumer device, occurs in certain locations. An alert engine or other system can then analyze the user's transactions and send the user a message every time (or aggregated at certain intervals) a transaction in the specified location occurs. In some embodiments, a user account alert message can be sent to one or more users associated with the user account whenever a user account event occurs at a specific merchant, merchant type, website, or zone.

For example, if a user's card is ever used in Las Vegas, that user or other designated user can receive a user account alert that includes information associated with the transaction and the location. Similarly, a principal user, such as a parent, can request that a user account alerts be sent to his or her phone whenever a secondary user, such as a child, uses and associated portable consumer device, i.e. a credit card, to conduct a transaction in an area or at a merchant that the principle user deems inappropriate. For instance, a parent user may wish to be notified whenever a child user uses a credit card to buy gas in a zone that is considered unsafe or a merchant known to sell adult materials and/or alcohol.

In various embodiments, users can specify very specific user account event locations that will trigger a user account alert. The locations can be referred to and flagged as triggering locations. Locations can carry multiple flags that can be used by different users to create different sets or definitions of user account alerts or trigger criteria. The locations and the flagged triggering locations can be used to define a safety zone alert triggering event.

In some embodiments, the safety zone alert triggering event can include or be based on a list of addresses or zip codes. In other embodiments, the safety zone alert triggering even can include or be based on lists or definitions of high crime or high fraud areas. The high crime or high fraud areas can include or be based on a law enforcement agency report or law enforcement database.

A shown in FIG. 7C, triggering locations can include, but are not limited to, merchant 750, point-of-service terminal 760 and website 770. Each triggering location can include a number of flags or characteristics that can be assigned by users, issuers or the intelligent notification/alert engine 230. The flags can be descriptive of the type of location or the type of transaction conducted at the location.

For example, merchant 750 can be associated with the merchant record 755 and be flagged with various fraud/problem reports. The fraud/problem reports can include, but are not limited to, caution flags, fraud flags, crime flags, skimming flags, overcharge flags, or generic dubious merchant flag. Similarly, locations including point-of-service terminal of 760 and website 770 can also have related point-of-service record 765 and website record 775 listing the various flags associated with those locations. As such, issuers, users and intelligent notification/alert engine 230 can specify trigger criteria that include a designation of any combination of such flags.

Location Based Transaction Velocity

In other embodiments, user account alerts and trigger criteria can be based on the geographic zone and the time or date associated with a particular user account event. For example, the issuer or the intelligent notification alert engine 230 might know that a user associated with a particular credit card account resides in zone 5 and works in zone 3. This information may be based on information provided by the user or can be established by analyzing previously observed user account events such as credit card transactions. Based on the analysis, the issuer or the intelligent notification/alert engine 230 might develop usage trends based on the geographic area, day of the week and time of day. Therefore, for the user described above, credit card transactions involving gasoline and/or food during the workweek and during normal business hours can be expected in zone 3 despite the fact that the user resides in zone 5. The use of observed geographic locations associated with user account events can be used in various ways and will be discussed in more detail below in reference to other user account alert and trigger criteria types.

In various other embodiments, user account alerts and trigger criteria can be based on time and geographic differentials between successive user account events. For example, issuer or intelligent notification/alert engine 230 can observe a series of card-present credit card transactions. The first card-present credit card transaction occurs in zone 5 at 1 PM on a Monday, the next transaction in zone 2 at 1:10 PM and a third transaction occurs in zone 4 at 1:15 PM. Because it is highly unlikely, if not physically impossible, for a single credit card, or other portable consumer device, to present in zones 5, 2 and 4 for three different credit card transactions within 15 minutes of each other, the issuer or the intelligent notification/alert engine 230 can determine that the series of credit card transactions must involve some number of unauthorized copies of the credit card. As such, it is highly likely that the copies of the credit card are fraudulent as are the associated credit card transactions. In such situations, an alert may be sent to a consumer's communications device shortly after a transaction that illustrates an unlikely pattern is conducted, or at some later time.

Description of the differential between time and locations of a series of user account events can be referred to as location-based transaction velocity. The metric can be defined as the distance between two successive observed user events divided by the time between the two observed user events. One possible expression of location-based transaction velocity, V_{Geo}:

$${V}_{Geo} = \frac{Δ D}{Δ t} = \frac{{l}_{2} - {l}_{1}}{{t}_{2} - {t}_{1}}$$

In such an embodiments, l₁ can be the geographic location of one transaction, l₂ can be the geographic location of a subsequent transaction, t₁ can be the time of the first transaction and t₂ can be the time of the subsequent transaction. The format of the geographic locations can be any form suitable for determining physical distances between user account event locations.

The location-based transaction velocity can be used to define a triggering event based on the difference in time and location between the observed user account event and a previously observed user account event. In such embodiments the triggering event based on the difference in time and location between the observed user account event can include a threshold value for the difference between the in time and location of two or more previously observed user account event and newly observed user account event. The threshold value for the triggering event based on the difference in time and location between the observed user account event can be set by an account issuer or the notification engine and be base on a set of physical travel limitations. For example, it may be impossible for a single authorized user to be at a first location one minute and then at a second location 400 miles away the very next minute.

In some embodiments, the geographic locations can be designated by zip codes, addresses or GPS coordinates. The time stamps or other temporal designations associated with each observed user account event can be in any format suitable for determining different differentials in actual time. In some embodiments, it may be necessary to translate the time stamp from one time zone to another.

In this way, and issuer, intelligent notification/alert engine 230 or the user can designate a threshold value for location-based transaction velocity. For example, a user who does not travel between states may designate a location-based transaction velocity threshold of 100 miles for a one-hour time period. In the context of credit card transactions, this would mean that any credit card transactions that occurred more than 100 miles apart from each other within an hour would trigger a user account alert. However, other users may need a larger threshold value.

A business person, such a salesperson, may commonly travel between 500 and 1000 miles per day within the same country. Such a user may wish to set a threshold value of 1000 miles per any five hour period. The designation of the appropriate location-based transaction velocity can depend on the characteristics of the individual user or user account. Such characteristics can include, but are not limited to, age, gender, sex, size, height, race, ethnicity, nationality, home address, work address, date of birth, place of birth, hobbies, interests, or occupation. In some embodiments, it is not the user, but rather the issuer or the intelligent notification/alert engine 230 that determines the appropriate location-based transaction velocity threshold or the allowable tolerable deviation from normal usage. In such embodiments, the issuer or the intelligent notification/alert engine 230 can analyze historical user account usage and trends to characterize the typical behavior and usage associated with a particular user or user account and define a threshold location based transaction velocity.

Transaction Result Type

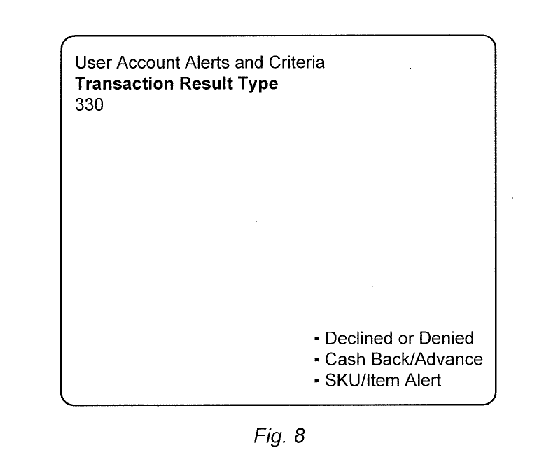

FIG. 8 shows examples of transaction result type user account alerts and trigger criteria according to various embodiments of the present invention. As shown, transaction result type 330 can include requests for a user account alerts to be sent to one or more users associated with a particular user account when an attempt to use that user's account in a user account event results in a declined or denied transaction, a cashback or cash advance transaction, or involves a specific item identifier.

Declined or Denied

In some embodiments, a user account alert can be sent to one or more users when a requested user account event is declined or denied by a merchant, a payment processing system or other entity. For example, a user, issuer or intelligent notification/alert engine 230 can determine that a user account alert should be sent to a user whenever that user's credit card is declined. In some embodiments, the reason for the credit card being declined can be included in the user account alert. Reasons that a credit card transaction is declined can include, but is not limited to, lack of funds, account being over the limit, no ID presented in a card-present transaction or an incorrect card verification value being provided. In some embodiments, the determination to send the user account alert based on an observed denied or declined user account event can be made independently of user input or interaction. User account alert message can include a “softening” message, which can explain the circumstances to the user without engendering any ill will.

Cashback and Cash Advance

In other embodiments, a user account alert message can be sent when an observed user account events involves the request, processing or successful completion of a cashback/advance transaction. In the context of credit cards, a user, either authorized or unauthorized, can request cash back from a merchant or point-of-sale terminal in addition to a requested financial transaction, such as a credit card purchase. In such transactions, a cash value can be added to the total amount of a separate financial transaction and applied against the credit card account. Thus, the user is billed the total amount of the transaction which can include the purchase price of the item or service, the amount of cash received at the end of the transaction and any applicable fees charged by the issuer or other entity. Since some credit card companies charge different interest rates and fees for cash advances against credit accounts, it is often desirable to alert the user before the completion of a cashback or cash advance transaction is allowed in association with the credit card transaction.

For example, a user can present a credit card to a merchant to purchase a load of groceries. Before the credit card purchase of groceries is completed, the merchant can add a cash amount to the total amount charged for the load of groceries. The amount charged to the user's credit card account in excess of the cost of the groceries can be returned to the user as cash. In some embodiments, a user may wish to be notified when his or her credit card account is being used to obtain cash before the transaction can be completed thus avoiding any possible fees and differential interest rates on the cashback or cash advance amount. This can be particularly helpful when more than one user is associated with a particular credit card account. The principal user of the credit card account, the user who may be financially responsible for paying the credit card bill, might want to limit the amount of cash that can be obtained against the credit card account. Thus, when intelligent notification/alert engine 230 detects a user account events requesting a cashback or a cash advance, a user account alert can be sent. In some embodiments, user account alert can include a request for verification or user feedback to either allow or decline the cashback or cash advance request. In such embodiments, the request for cashback or cash advance is the observable user account event.

Similarly, cash advances using the credit card account can often be obtained using Automatic Teller Machines (ATM). As with the cashback request, which often accompanies a credit card purchase of a separate item or service, detection of n ATM cash advance against a credit card account can also trigger a user account alert. In some embodiments, a threshold cash back or cash advance value can be determined by a user, issuer or intelligent notification/alert engine 230. In such embodiments, a user account alert will only be sent if the cashback or cash advance value being requested, processed or completed his above the threshold value.

In some embodiments, when a transaction is declined or denied, a message may be sent to the user that a decline has occurred with an explanation (i.e., the reason(s) for the decline).

SKU and Item Identifier

In various embodiments, a user account alert message can sent to one or more users when an associated user account is used to select, store, order or otherwise purchase particular items and services. Both brick-and-mortar and online merchants use various item identifiers, such as Stock Keeping Unit codes (SKUs) and Universal Product Codes (UPCs), to identify individual products and services. When an observed user account event involves a specified item, user account alert can be generated and sent to one or more users. The triggering user accounts event can be predefined. The predefined user account triggering events can be include or be based on item identifier alert triggering event.

In some embodiments, the item identifier alert triggering event can include or be based on specific lists of items identifiers or item type identifiers. For example, an item identifier alert triggering event or trigger criteria can include or be based on a credit card account being used to purchase an item having an item identifier stored in a list or database of preselected trigger item identifiers or item type identifiers. The list or database of preselected trigger item identifiers or item type identifiers can include or be based on a list of prohibited product identifiers or prohibited service identifiers. The list of prohibited product or service identifiers can be based on a characteristic of one or more user associated with the user account in question. For example, the list of prohibited product or service identifiers can be based on the age of the principal or subsidiary account holder associated with the user account.

For example, a user, issuer or intelligent notification/alert engine 230 can determine a list of items types including all alcoholic beverages, cigarettes, and adult materials will generate a user account alert when a user account event involving identifiers for such items is observed. The list or database of preselected trigger item identifiers or item type identifiers can be compiled by the user, issuer, payment processing network or the intelligent notification/alert engine 230. The trigger item identifiers or item type identifiers can be compiled from one or more registries of item identifiers, such as those maintained for SKUs or UPCs. The list of trigger item identifiers or item type identifiers can be deliberately and predetermined by the user, issuer, in a processing network or an intelligent notification/alert engine 230. Such SKU information may be transmitted in an authorization request message that is sent from a merchant to an issuer via a payment processing network and an acquirer.

In alternative embodiments, as discussed in further detail below, can be based on the classification determined by analysis of prior user account events. By analyzing prior user account events and the item identifiers or item type identifiers associated with some baseline of prior user account events, a trend of acceptable and unacceptable item identifiers and item type identifiers can be developed. Any user account event involving an item identifier are item type identifier that is inconsistent with the trend of acceptable/unacceptable item identifiers and item type identifiers can trigger a user account alert message to be sent to one or more associated users.

A user account alert can also be generated when a user signals an intention to purchase a particular item, but prior to the actual purchase. A user can signal an intention to purchase an item, for instance, by adding the item to a “shopping basket” or “shopping cart” while shopping online (e.g., using a merchant website). For example, a user account alert message can be sent to one or more users when an associated user, either by association with the online merchant account or the credit card account, places and item having an item identifier found in the lists of triggering item identifiers or item type identifiers into the online shopping cart.

Some online merchants also have online “wish lists” or gift registries that users can use to indicate items or services they wish to receive as gifts or donations. In such embodiments, the online merchants can offer online accounts to users and allow the users to associate other users to whom they would like a user account alert sent when items are added to the wish list or gift registry.

In other embodiments, user account alerts can be sent regarding back ordered items. For example, many online merchants allow users to maintain standing order accounts which are shipped to the user on a regular basis as part of a standing order. For example, some online grocery merchants allow users to specify a weekly shipment of fresh food products such as milk, eggs and fresh vegetables. If for some reason, any item in a standing order account is not immediately available and therefore will ship separately or have a substitution ship in its place, then a user account alert message can be sent informing the user of the status of the standing order account.

The use of item identifiers and item type identifiers to generate user account alerts is helpful in curtailing potential fraud using a particular user account. For example, some credit card fraud can involve purchases of product categories such as jewelry, shoes and other high-priced luxury goods. Thus, it is desirable to send a user account alert to a user every time the user's account is observed to be involved in a user account event involving specific item or item type identifiers, such as those associated with high-priced luxury goods. Such user account alerts can assist in quicker determination of fraudulent transactions, and can prevent future fraudulent occurrences.

Similarly, a variation of a user account alert message being sent when a particular item identifier is observed in a user account event, can involve a user account alert being sent to a user upon the return of a particular product. The user account alert can contain the amount of money refunded to the user's account, allowing the user to verify the information and correct any overcharges or under refunds.

In other embodiments, user account alerts can be sent to users after a user account event has been completed regarding the specific details of the user account event. For example, a user can be sent a user account alert including comparisons of the price just paid for any or all of the purchases charged to the credit card account at a particular merchant, to prices offered by other merchants. This can include any closeouts, sales, or other lower priced options. The message can include the merchant names, addresses, and other contact information. For example, a consumer may purchase an item from a first merchant. After the sale has completed, intelligent notification/alert engine 230 or other system can recognize an item identifier for one of the items purchased, such as a SKU or UPC, and use the item identifier to compare the price of the credit card transaction with prices listed by other merchants. The intelligent notification/alert engine 230 can then send a user account alert to the user that includes information on any lower priced alternatives.

In yet other embodiments, the user account alert regarding potential lower priced options from other merchants can be sent to the user when the user places a particular item having an item identifier into an online shopping cart or otherwise indicates his or her intention to purchase the particular item. In such embodiments, the user account alert can be sent before the purchase of a particular item thus allowing the user determine whether they want to complete the purchase at the original merchants price.

In various embodiments, a user account alert can be sent to a user after a user account event has been completed to send various guarantees or warranties involving items or services involved in the observed user account event. For example, if the user purchased a warranty or a product or service in the credit card transaction, a user account alert message can be sent informing the user that the merchant is likely to go out of business soon, or to any other situation that may prevent the warranty from being honored. Alternatively, the user account alert can be sent to inform the user of the specific details of a warranty or guarantee associated with a particular purchase of an item or service.

Device Type

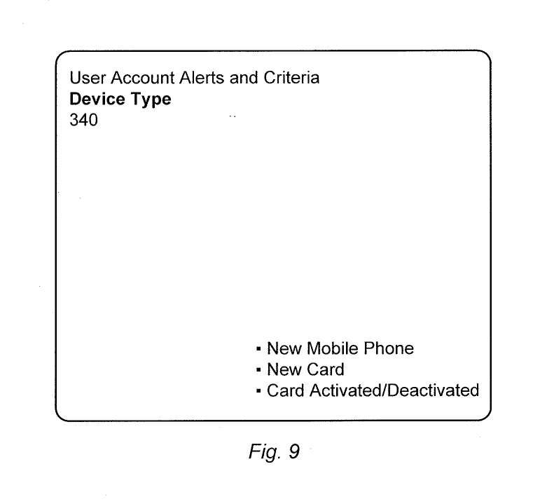

FIG. 9 shows examples of device type user account alerts trigger criteria according to various embodiments of the present invention. As shown, user account alerts can be sent to a more users associated with a particular user account when various information involving portable user devices is available, updated or changed. The type of information can be used in device type user account alerts and trigger criteria includes, but is not limited to, information regarding the purchase, issuance or activation of a new portable consumer device such as a new mobile telephone, a new credit card or when an existing portable consumer device is deactivated or otherwise decommissioned.

The user account can have a flag associated with it indicating to an issuer, a payment processing network or an intelligent notification/alert engine 230 that a user account alert should be sent to the user anytime a new mobile phone or other mobile communication device is registered with the account. For example, a mobile telephone service provider account can include multiple mobile communication devices or telephones. A primary user may wish to be alerted to the issuance or activation of any new mobile telephone or communication device with the existing mobile telephone service provider account. In other embodiments, the credit card account or online merchant account can be associated with a mobile telephone number. In such embodiments, the credit card issuer or the online merchant can use the associated mobile telephone number to send user account alerts to the user. If a new mobile telephone number is associated with the credit card account or online merchant account, a user account alert can be sent to a previously associated mobile telephone number to verify that the change of mobile telephone numbers was not part of an attempt to commit fraud on the user account.

In some embodiments, the user account alert message can be initiated when a triggering user account event involving a new device alert triggering event is observed. The new device alert triggering event can include or be based on a definition of a newly activated credit card or mobile telephone. The definition of a newly activated credit card or mobile telephone can include the use of a newly issued credit card in a purchase transaction or the use of a mobile telephone being used for the first in association with a new or existing mobile telephone service account.

In other embodiments, the user account alert can be sent to user when a new portable consumer device, such as a credit card or identification and verification token, is issued. Such user account alerts can help the user determine whether or an attempt to commit fraud on the associated user account by an unauthorized user requesting a new portable consumer device. If the authorized user associated with user account did not request a new portable consumer device, then the authorized user can intervene and have the newly issued portable consumer device canceled. In related embodiments, if the user responds to the user account alerts that the new portable consumer device has been fraudulently requested, another user account alerts can be sent to law-enforcement officials with whatever information is available regarding the unauthorized new portable consumer device request, i.e. the mailing address to which the new portable consumer device was to be sent.

To prevent fraud, some neural networks that monitor credit card and debit card transactions can detect suspicious activity and unilaterally deactivate an associated credit card or debit card. If the credit card or debit card is deactivated in an effort to curtail potential fraud, then a user account alert can be sent to the authorized user. User account alerts can inform the user that his or her credit card has been deactivated so to avoid any possible embarrassment, inconvenience or cancellation of purchases or services caused by presenting a currently deactivated portable consumer device to merchant.

In certain embodiments, an alert can be sent within moments of a transaction occurring. These alerts can be used to validate merchant identities, to clean up bogus records, and to rate merchants. In some implementations, an action of the user (such as conducting a transaction) can trigger an alert regarding a merchant. For example, users often may visit the same merchants repeatedly. An alert can occur when a user visits a merchant not previously visited by the user. In a second example, users often use their portable consumer device within a known “type” (i.e., “category,” or “class”), of merchants. An alert can be triggered when a user makes a purchase from a merchant category that is outside of the normal pattern for the user. In some embodiments, an alert can be generated for a merchant with a dubious reputation or a known fraud risk. The alert can comprise a message including information on the merchant. For example, the message may warn the user that the merchant website is a fake website used for phishing or other fraud. In certain implementations, the user may respond to the alert (such as by a reply message, logging onto an appropriate website, etc.) with a rating of the merchant. This rating can be used for future alerts.

In various embodiments, an alert can be sent to users based upon unlikely user account events or activity. The alert can notify the primary user of a portable consumer device account when a portable consumer device is being used for an activity that is unlikely or unusual. These alerts can use the profile of the user and other risk tracking information to generate alerts. In one aspect, the alerts can be generated by combining information on the merchant category with the characteristics of the user. For example, an alert can be sent to the primary account holder when a subsidiary card, specified for a minor (i.e. the account holder's child), is used to make a liquor store purchase. In another example, an alert can be sent when the portable consumer device of an elderly person is used to make a purchase for a parachuting class.

Miscellaneous User Account Alerts and Trigger Criteria

Privacy and Background Checks

In various embodiments, user account alerts can be sent to users regarding privacy issues. For instance, the user account alert can inform the user that someone has used the user's portable consumer device or financial account for a background check. For example, an entity such as Yahoo!™ may perform an address verification service (AVS) transaction to verify a user's or other personal information, prior to opening an email account for the user. In such an AVS transaction, Yahoo!™ may see if a nominal amount, such as $1, can be authorized to a user's credit card account using the associated billing address, but may never collect the amount, just to ensure that the identity of the requesting user is authentic. The intelligent notification/alert engine 230 or other system can determine that the AVS transaction has occurred, and can then alert the user regarding the use of the user's account.

User account alerts can be initiated whenever a triggering user account alert event is observed. The triggering user account alert event can include a privacy alert triggering event. The privacy alert triggering event can include or be based on a definition of an identification or an address verification request.

User Account Status Updates

In certain embodiments, user account alerts can be sent regarding updates to issuer information, merchant information, user account information, portable consumer device information or any other information regarding a portable consumer device. In some embodiments, the updated information involves the status of a user account, such as when the user account has been disabled, or in the case of user credit card account, when there is has been an increase or decrease in the credit limit of the account or similar updates. The user alert/update message can include specific information regarding the update or change or simply inform the user that update information is available. The alerts can also be triggered based upon the merchant location, or can be used for user services (and can utilize bidirectional SMS messages), for new mailings of portable consumer devices, for activation of portable consumer devices, and for transfer of a balance to a new account for a portable consumer device.

In certain embodiments, an alert can be sent to a user to confirm account changes. For example, a user may have lost their portable consumer device (e.g. their phone including account information), and may decide to discontinue certain services such as alerts. An alert may be sent to the user's new phone, by the issuer, payment processing system, etc., asking if the user would like to re-enroll in the alerts program. The user may send a reply message to re-enroll, or may reply in the negative to ensure no further alerts are received.

Tip Alerts

In certain embodiments, alerts and related messages may be directed to gratuities, such as tips at restaurants. In certain implementations, a user may receive a message after the transaction has been pre-authorized (such as at a restaurant and prior to the tip being added to the bill). The message can state, for example, that “the card was used for dining” and the message may leave out the transaction value. Alternatively, the message may include the value and note that the actual value may vary (to account for the tip). In exemplary implementations, a user might enter a tip into a phone or other device (such as by replying to the above described message). The tip entered by the user (e.g., included in the reply message) may then be processed and added to the transaction bill, without having the user manually enter it on a receipt. This can ensure that the gratuity is the exact amount desired by the user, and can prevent later changes to the amount.

Usage History/Trend Type

FIG. 10A shows examples of usage history/trend type user account alerts and trigger criteria according to various embodiments of the present invention. By referencing prior user account events, intelligent notification/alert engine 230 can make determinations regarding what is and is not typical usage of the associated user or user account. Intelligent notification/alert engine 230 can analyze the prior user account events to develop and classify the historical usage of the account and/or develop profiles of the associated authorized users. The historical usage of a particular user or user account can be classified in terms of activity trends or patterns.

For example, prior user account events can include information regarding past financial transactions such as credit card purchases. The past financial transaction information can include various levels of transaction level detail such as time, date, amount, location, merchant identifier, merchant type, and the product or service codes associated with the particular user account event. With this information, the intelligent notification/alert engine 230 can characterize the prior usage history of the user account or the spending habits of the authorized users. For instance, one particular user associated with a user account, may typically only use his or her credit card account “A” to purchase groceries and gasoline. This can be reflected in three years of stored credit card transactions associated with credit card account “A.” Thus, credit card account “A” can be classified as a household expense account. If however, credit card account “B” is typically used to make seasonal purchases for gift items, credit card account “B” to be classified as an occasional use credit card account.

Once a credit card account has been classified, each new user account event, i.e. credit purchase using that credit card account can be compared against that known classification to see if it is consistent with that classification. If, for example, a credit card purchase of a new fur coat using credit card account “A” is observed, the intelligent notification/alert engine 230 might determine that the credit card purchase is inconsistent with the classification of the credit card account “A.” In other words, the observed user event is inconsistent with the historical usage, or spending trend, of the credit card account “A.” When such an inconsistent user account even is observed, the intelligent notification/alert engine 230 can then determine whether or not a user account alert should be initiated.

Whether a user account alert is initiated can depend on a number of factors. In some embodiments, the determination to send a user account alert will depend on how inconsistent the observed user account event is or how much it deviates from the expected trend. The measure of the consistency or deviation from the expected trend can be determined from the characterization of the user account or the associated authorized users. Usage history/trend type user account alerts and criteria can include analysis of various types of irregular user account velocity, typical safety zones and other unlikely user account events.

Irregular Location Based Transaction Velocity

In various embodiments, a user, account issuer or intelligent notification/alert engine 230 can request a message be sent to a user when an abnormal number of transactions using a particular user account are observed. In the context of credit card transactions, the number of transactions in a given period can be referred to as a transaction rate, such as the number individual purchase transactions or the combined amount of the purchase transactions made using a user's credit card account over some time period.

As mentioned above, the basic transaction velocity can be combined with location based services to measure the relative distance between two or more successive transactions. Using the location and time information associated with the observed user account events, the location based transaction differential can be determined. By observing the typical locations and location based transaction velocity associated with a particular user account or user, a baseline, trend or expected location based transaction velocity for that user or user account can be established. When the location based transaction velocity exceeds a threshold deviation from the baeline, trend or expected location based transaction velocity, a user account alert can be sent to one or more users.

The threshold to determine an abnormal number of purchases or an improbable distance measured between successive card-present credit card transactions can be based on a user's transaction history or the user's preferences.

In some embodiments, the threshold can be set to a preferred monetary amount transacted in a single day (or week, month, etc.), or in a single transaction, etc. In some embodiments, the threshold can be based on the number of transactions within a given time period as long as the transactions are within 100 miles of each other. Additionally, such values can be independent of monetary amounts, or may be combined with a monetary amount threshold.

In one embodiment, a user can configure an user account alert that notifies the user when the user's portable consumer device has been used more than 5 times in a single day and in more than three zones. In another example, a user could configure an alert to be sent to the user when the user's hourly/daily velocity norms are exceeded. This threshold can be combined with a location differential to ensure that one or more fraudulent cards have not been produced and being used in attempted unauthorized credit card transactions in multiple distant places.

In other embodiments, the payment processing system, the issuer, intelligent notification/alerts engine 230 or other entity can determine the thresholds, based upon statistical averages and/or historical models. When an entity other than the user determines the trigger criteria and threshold values based on historical or prior user account events, the user need not intervene. However, in some embodiments, it may be useful to have a user opt-in or opt-out of prior user event analysis to avoid possible unwanted user account alerts from being sent to the user. The user account alert can be one way (to the user), or may be bidirectional, allowing the user to reply, i.e. using SMS messaging.

Timeline 1010 in FIG. 10B shows an example of one possible improbable series of user account events associated with a particular user account. For purposes of this example, the user account events located along timeline 1010 can be referred to as card-present credit card transactions with the understanding that they could just as well be any other type of user accounts events using a portable consumer device to initiate the user account event.

The horizontal dimension of the timeline represents the date or time. As shown, between date/time 1 and 2, a card-present credit card transaction is detected at location A. Since this is the first of the card-present credit card transactions in the series, the initial distance measured from the last observed card-present credit card transaction is 0. At sometime later, a card-present credit card transaction is observed at location B at a distance of 25 km from the last observed card present credit card transaction. The next observed card-present credit card transaction is observed at some date/time after 2 at location C at a distance of 25 km from the previous card-present credit card transaction and the next transaction D occurs at a distance of 2050 km. Finally, at some date/time between 3 and 4, another card-present credit card transaction is observed at location E at a distance of 75 km from the most recently observed card-present credit card transaction.

If we assume that the date/time units are hours, then it is highly unlikely that card-present credit card transaction was conducted with an authorized credit card at location C and then later at location D 2050 km away from location C less than an hour later. Because it is very improbable, if not impossible, to have an authorized credit card presented at these to distant locations within such a short timeframe, a credit card issuer, a payment processing network for the intelligent notification/alert engine 230 can determine to send the user account alert to one or more users.

However, if the date/time units are days, none of the observed differences in distance between successive locations is necessarily unlikely or improbable. Users can easily fly 2050 km in less than a day. Therefore it is not necessarily unlikely that a user could conduct a card present credit card transaction, at say an airport, fly to his or her destination 2050 km away and then use their credit card to conduct another transaction. In such embodiments, it may be helpful for the intelligent notification/alert engine 230 to refer to prior credit card purchases to verify that perhaps the user used the same credit card account to purchase an airline ticket. In other embodiments, intelligent notification/alert engine 230 can analyze the activity of other credit card accounts or debit card accounts associated with the same user to see if he or she used one of those accounts to purchase an airline ticket when the original credit card account was not used to purchase airline ticket.

The tracking of the distances or location differentials between successive user account events can also be coupled with the analysis of prior user account events. For example, if a user tends not to travel too far from home as indicated by his or her typical credit card account activity, then it would be unlikely that user would have flown 2050 km away to make a card-present credit card transaction. The intelligent notification/alert engine 230 can also verify that the user does not use a separate credit card when traveling long distances. In such embodiments, intelligent notification/alert engine 230 can produce a user or user account profile across one, some or all of the user accounts associated with a particular user to generate a profile of historical user account usage or an expected trend of usage. If any observed user account events deviate from the established profile or expected trend, then a user account alert can be sent to the user to inform the user that a possibly fraudulent portable consumer devices, such as credit cards, may be in use.

Other Irregular User Account Activity

As mentioned above, prior user account events, such as credit card transactions, can be recorded and later analyzed as part of a series of user account events to establish a profile of a user account or one or more of the associated users. The type of analysis and profiles established can involve many types of user characteristics, habits and patterns as well as typical user account usage trends.

For example, timeline 1020 shows three prior user account transactions; transactions X, Y and Z. The intelligent notification/alert engine 230, or some other system, can analyze these transactions to determine what types of future transactions can be expected and, consequently, what types of transactions might trigger a user account alert. The analysis can include an examination of any information associated with the user account events such as information used to define some or all of the user account alerts and trigger criteria discussed above in reference to FIGS. 7A, 7B, 7C, 8 and 9.

In one embodiment, historical prior user account events can include the location, merchant identifiers, merchant type identifiers and times associated with transactions X, Y and Z and be analyzed to determine a trend of usage habits and patterns for either the user or the user account. For example, an 85-year-old woman may use her debit card to purchase groceries from her local grocery store every Monday morning (transaction X). On her way home from grocery shopping Monday morning, she may stop by a local café and use her debit card purchase her supply of coffee for the week and treat herself to a café mocha (transaction Y). Later in the week, usually on Wednesdays, the same woman may walk to her local pet store to purchase cat food (location Z). The total amount week's worth of debit card transactions would be equal to the total amount of each transaction, or in other words X+Y+Z. Other than that, the woman rarely uses her debit card for any other purchases.

The profile or expected spending pattern might include a description or a number of thresholds, that can use independently or in combination with one another, to determine when the user account alert message should be sent. In this particular simple example, the woman's debit card account, might indicate that she usually uses her debit card for food and pet supply purchases under $100 in a 4 mile radius around her home. Her spending patterns may also indicate that she typically spends less than $500 using her debit card in any given month. If the intelligent notification/alerts engine 230 observes any debit card transactions conducted with her debit card that suspiciously exceeds such trigger criteria, it can determine to send her a user account alert. For example, if her debit card is observed as being involved in a transaction for $300 at an adult bookstore 60 miles away from her home, the user notification/alert engine 230, or some other system, can determine that such a debit card transaction is highly suspect and that the user account alert should be sent.

Furthermore, the user or user account spending profile or expected spending trend can include user specific information for the authorized users. For example, in the above example of the 85-year-old woman, it may be highly suspect for her to use her debit card to pay for parachuting lessons or birth control, even if the debit card transaction is for less than $100 and occurred at her typical stores within a 4 mile radius of her home. In such embodiments, the item identifiers and item type identifiers associated with prior user account events can be used to generate an even more detailed profile of expected user account events to be compared against observed user account events.

In some embodiments, the analysis of prior user account events can include very detailed user habit profiles and user account usage trends that can be used by the intelligent notification/alert engine 230 to determine if any newly observed user account events should be brought to associated user's attention using a user account alert. The number of prior user account events analyzed or the timeframe over which they are collected can vary to account for normal changes in user behavior and user account usage over time.

In timeline 1030, prior user account events or transactions A through W are shown as occurring between date/time 1 and 4, where transaction W represents the most recently recorded prior user account event and transaction A represents the first recorded user account event. Some or all the information associated with each of the transactions can be analyzed depending on the number of transactions or the timeframe deemed to be relevant. For example, the intelligent notification/alert engine 230 can determine that only transactions that occurred within the last two months should be included in the analysis. If the date/time units along the timeline 1030 represents months, then only transactions J through W would be included in the analysis. Alternatively if the intelligent notification/alert engine 230 determines that only the last 13 transaction should be included in the analysis, then only transactions K through W would be included.

In various embodiments, any information related to user, issuers or intelligent notification/alert engine 230 defined user account alerts and trigger criteria discussed above or the designated prior user account events can be analyzed to generate or otherwise determine the profiles and usage trends for the users and user accounts associated with the prior user account events.

For example, the location-based information associated with each prior user account event, which can include zone identifiers, such as zip codes, addresses, merchant identifiers and merchant type identifiers, can be analyzed to determine a usage profile for a particular user or user account. For example, analysis of the user's credit card transaction history may indicate that the user only shops for his or her groceries at national chain supermarkets within a 10-mile radius from home. Intelligent notification/alert engine 230 can then create a user account profile classifying the user and/or the user account as a national chain supermarket customer. If, later on, intelligent notification/alert engine 230 observes the user or the user's associated user account being used to purchase groceries at a local grocery store 30 miles away from his or her home, and the user account alert message can be sent.

To enhance the usefulness of the profiles and usage trends, information associated with multiple user account alerts and trigger criteria discussed above can be analyzed to generate composite user and user account profiles or usage trends. Composite user in user account profiles or usage trends provide a tool with which intelligent notification/alert engine 230 can use to analyze observed user account events at a deeper or more detailed level. To continue with the example of the user classified as national chain supermarket customer based on his choice of grocery merchants, it is possible to look at the items associated with the prior user account transactions in the supermarkets to further define the user profile or user account trend. For example, the item identifiers or item type identifiers associated with the user's prior supermarket credit card purchases can indicate the user only purchases organic produce, dairy and poultry. In the range of prior supermarket credit card purchases, there have been no observed purchases of red meat or alcohol. As such, the user profile or the user account usage trends can be further updated. Thus, any observed credit card transactions at a supermarket that involves alcohol or red meat or the purchase of nonorganic produce, dairy and poultry may trigger a user account alert.

Composite User Account Alerts and Trigger Criteria

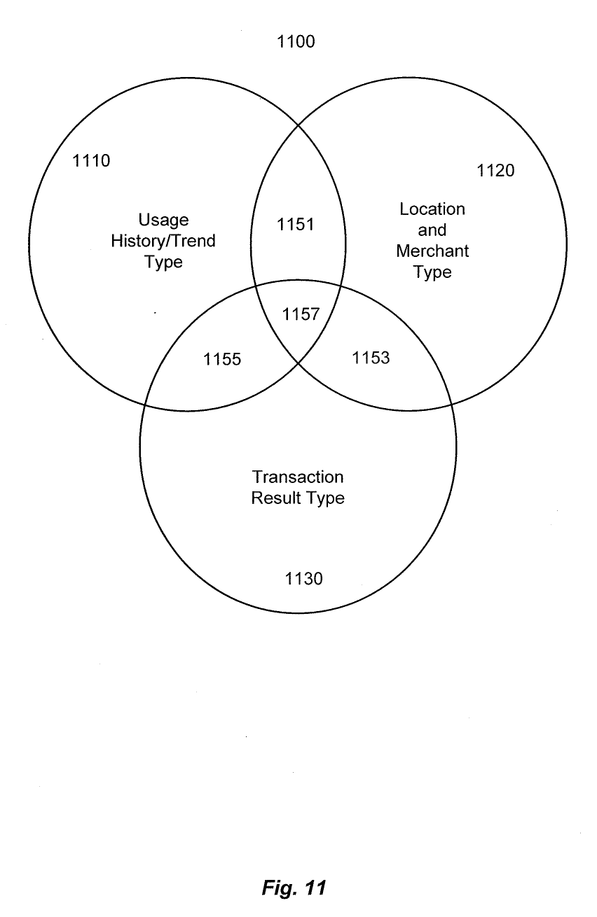

FIG. 11 is a Venn diagram of exemplary composite user account alerts and trigger criteria according to various embodiments of the present invention. As shown you usage history/trend type triggers 1110, location and merchant type triggers 1120 and transaction result type triggers 1130, can be combined or overlaid on one another to create new categories of user account alerts and trigger criteria.

For example, as discussed above, usage history/trend type trigger criteria can be combined with other types trigger criteria to generate threshold values using prior user account events with or without requiring the user to intervene or sets preferences. Regions 1151, 1155 and 1157 represent the intersection between usage history/trend type user account alerts and trigger criteria 1110 and location and merchant type and transaction result type user account alerts and trigger criteria 1120 and 1130. Such types of user account alerts and trigger criteria provided for more flexible and adaptive way to detect triggering user events. It does not require the user, issuer or intelligent notification/alert engine 230 to anticipate and defined threshold values for each and every possible user account alert the user or issuer may find relevant or helpful, thus saving time, resources and expense. Additionally, the composite user account alerts and trigger criteria improve the chances that unauthorized or otherwise fraudulent user account activity will be detected and reported, thus increasing the effectiveness of the intelligent notification/alert engine 230 in the user account alerts it generates.

Similarly, location and merchant type 1120 and transaction result type 1130 user account alerts and trigger criteria can also be overly combined. Such composite user account alerts and trigger criteria shown as region 1153 can allow users, issuers and intelligent notification/alert engine 230 to define what kind of transactions at various locations in merchants will trigger user account alerts. For example, the user may specify that cash back transactions at merchant types other than grocery stores should trigger a user account alert.

Multiple Users Associated with a User Account

In various embodiments, multiple users or multiple portable consumer devices can be associated with a particular user account. For example, many credit card accounts allow issuers to issue multiple credit cards to multiple users. In such cases, each credit card or user can have a unique identifier or sequence number to identify which credit card was used or which user initiated any particular credit card transaction. The unique identifiers can then be used to define user account alerts and trigger criteria, such the user account alerts and trigger criteria discussed above, for each individual user or portable consumer device.

In some embodiments, a business or a household may have multiple portable consumer devices, each associated with a single financial account. However, each individual portable consumer device can contain a unique identifier. The intelligent notification/alert engine 230 or other system can determine which individual portable consumer device for a certain account has been used, and can customize user account alert and trigger criteria based upon this information. This allows a family or business to set up alerts for individual family members or individual employees. For example, a business may only authorize company credit cards to be used for payments for gasoline and airline tickets. A message can be sent to the business any time a company credit card is used for such purposes, or any time a company card is used for other purposes. The message can include an identifier for the individual portable consumer device, so that the business will know which employee was conducting the transaction. In another example, a message can be sent to the business regarding a transaction currently being conducted, and can include the portable consumer device identifier.

In some embodiments, the business can reply to the message (i.e., two way messaging), or by other communication means, to authorize or to deny the transaction. In a third example, a business may assign temporary payment cards to employees that are only to be used for selectable periods. The business may receive a message regarding the activation or deactivation of the payment card. The message can include the payment card identifier, allowing the business to manage multiple payment cards provided to employees.

In certain embodiments, an alert can be generated upon determining a transaction has been conducted for a “restricted use” using one of several portable consumer devices associated with group or business accounts. Such messages can help a primary or managing account holder control or monitor the use of portable consumer devices and the associated account. The issuer or a primary account holder can determine specific goods or services, categories of goods or services, or other groupings that might not be appropriate or authorized for a specific group type to whom the account and associated portable consumer devices have been issued. For example, a construction company may have a credit account with several credit cards associated with the account. The credit account may have been opened to allow employees and owners of the construction company to make fuel purchases, buy supplies at building supply stores and the like. Based on the type of the business or account type, in this example a construction company, and past usage of the account, the issuer, or a notification engine that is using the issuer's data, can determine that purchases at an online clothing retailer or golf shop might inappropriate use of the account. Once it is determined that the observed account event is inappropriate or suspect, a user account alert message can be initiated.

The determination that the observed user account event is inappropriate, or otherwise suspect, can be based on a classification of the account based information supplied by the primary account holder/user or the issuer when the account is initially opened or on past account usage and events. In the construction company example, primary account holder/user or the issuer may indicate that the account will only be used for construction company business. This may be a classification offered by the issuer with associated rules and criteria, however, in other embodiments, the classification may be an empty category that will be described and detailed over time as user account events are observed and prior user account events are analyzed. The more history regarding user account events that an issuer or notification engine has available to it, the more information about user accounts event trends and permissible and impermissible activity can be formed.

In the case of a construction company, a particular user account might only have been used at building supply stores to purchase building supplies for the past five years, then one day, suddenly; one of the credit cards associated with the construction company credit card account is used to purchase a set of golf clubs at a sporting goods store. As with all observed user account events, such as credit card transactions using the construction companies credit card account, the golf club purchase can be compared to the history of observed user account events or credit card transactions. This comparison will allow the issuer or the notification engine to determine whether the golf club purchase is consistent with one or more of the user account event trends documented in the user account history. Various levels of threshold deviations can be allowed to account for variations in user account events but may only slightly differ from the history of user account events.

For example, the user account may have been used to a particular type of product at a particular merchant for the last five years. In the construction company example, building supplies may have only been purchased from merchant X the last five years, and then all of a sudden building supplies are purchased at merchant Z. Although the type of purchase is consistent, i.e. purchase of building supplies, the merchant identifier as deviated. Based on the deviation of a merchant identifier, the issuer and or the notification engine can determine whether that deviation is beyond a threshold that it determines to be safe. If the deviation is not determined to be safe, the issuer or the notification engine can send a user account alert message to one or more of the primary user account holders. In the case of a construction company example, the user account alert message to be sent to the owner of the construction company or one of its responsible accountants. At that point, the owner the construction company or one of its accountants can decide how to proceed with information.

An advantage of various embodiments of the present invention is realized in systems which compare observed user events with the history or a trend of user account events determine whether a user account alert message should be sent without the account holder, or possibly even the issuer, deciding when and how a user account alert message is generated. This frees up the account holder or the issuer from having to decide on a vast number of possibilities in conditions that would trigger a user account alert message. In this way, account setup and/or user account alert message enrollment can be simplified to take less time and effort on the part of account holders and issuers.

Computer Systems

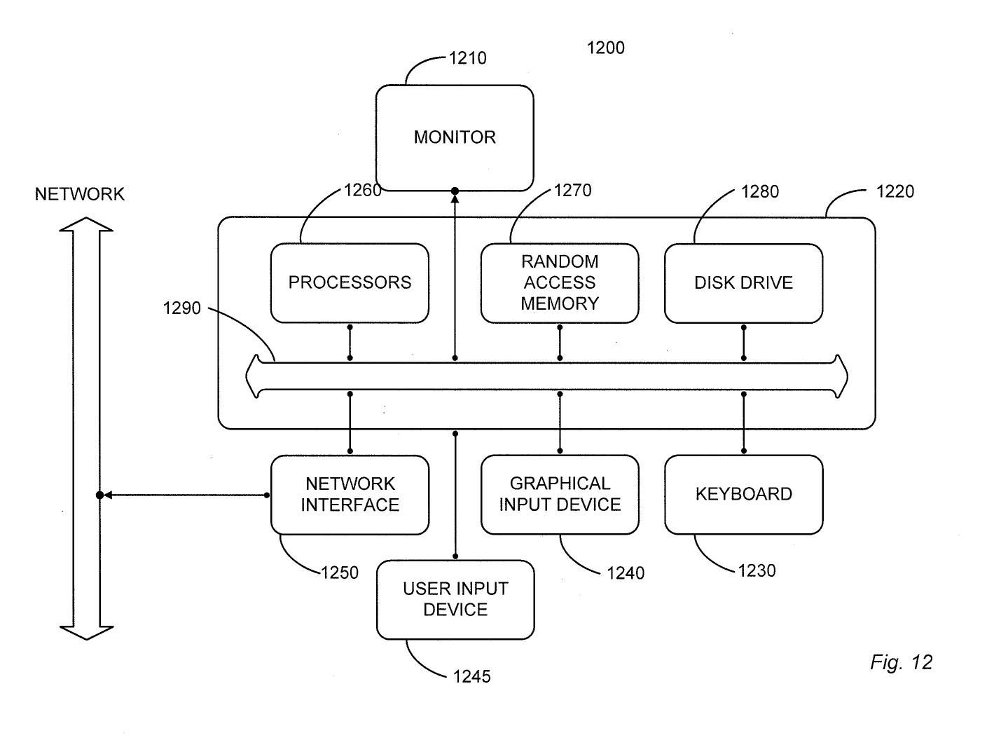

Any of the elements in FIG. 1-4 can use any suitable number of subsystems to facilitate the functions described herein. System 1200 in FIG. 12 is representative of a computer system capable of embodying various aspects of the present invention. The computer system can be present in any of the elements in FIG. 1-4, including notification engine 107, IP gateway 110, etc. Similarly, the various participants, entities and elements in FIG. 1 may operate one or more computer apparatuses to facilitate the functions described herein. It will be readily apparent to one of ordinary skill in the art that many other hardware and software configurations are suitable for use with the present invention.

For example, the computer may be a desktop, portable, rack-mounted or tablet configuration. Additionally, the computer may be a series of networked computers. Further, the use of other micro processors are contemplated, such as Xeon™, Pentium™ or Core™ microprocessors; Turion™ 64, Opteron™ or Athlon™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board. Various embodiments may be based upon systems provided by daVinci, Pandora, Silicon Color, or other vendors.

In one embodiment, computer system 1200 typically includes a display 1210, computer 1220, a keyboard 1230, a user input device 1240, computer interfaces 1250, and the like. In various embodiments, display (monitor) 1210 may be embodied as a CRT display, an LCD display, a plasma display, a direct-projection or rear-projection DLP, a microdisplay, or the like. In various embodiments, display 1210 may be used to display user interfaces and rendered images.

In various embodiments, user input device 1240 is typically embodied as a computer mouse, a trackball, a track pad, a joystick, wireless remote, drawing tablet, voice command system, and the like. User input device 1240 typically allows a user to select objects, icons, text and the like that appear on the display 1210 via a command such as a click of a button or the like. An additional specialized user input device 1245, such a magnetic stripe, RFID transceiver or smart card reader may also be provided in various embodiments. In other embodiments, user input device 1245 include additional computer system displays (e.g. multiple monitors). Further user input device 1245 may be implemented as one or more graphical user interfaces on such a display.

Embodiments of computer interfaces 1250 typically include an Ethernet card, a modem (telephone, satellite, cable, ISDN), (asynchronous) digital subscriber line (DSL) unit, FireWire interface, USB interface, and the like. For example, computer interfaces 1250 may be coupled to a computer network, to a FireWire bus, or the like. In other embodiments, computer interfaces 1250 may be physically integrated on the motherboard of computer 1220, may be a software program, such as soft DSL, or the like.

RAM 1270 and disk drive 1280 are examples of computer-readable tangible media configured to store data such user, account and transaction level data, calculated aggregated data, super keys, sub keys and other executable computer code, human readable code, or the like. Other types of tangible media include magnetic storage media such as floppy disks, networked hard disks, or removable hard disks; optical storage media such as CD-ROMS, DVDs, holographic memories, or bar codes; semiconductor media such as flash memories, read-only-memories (ROMS); battery-backed volatile memories; networked storage devices, and the like.

In the present embodiment, computer system 1200 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer 1220 typically includes familiar computer components such as a processor 1260, and memory storage devices, such as a random access memory (RAM) 1270, disk drives 1280, and system bus 1290 interconnecting the above components.

In some embodiments, computer 1220 includes one or more Xeon microprocessors from Intel. Further, in the present embodiment, computer 1220 typically includes a UNIX-based operating system.

Embodiments of the invention provide for a number of advantages. Such advantages may include the ability to provide useful alerts to consumers, based on trigger criteria that may not have been specifically specified by a user (e.g., when unlikely activity alert triggers are used). The ability to detect unlikely user account events and other activity is another advantage of the invention. Based on previously observed user account events, various embodiments of the invention can determine trigger criteria for specific users or user accounts without requiring a user, or even an issuer, to request or define all possible alerts that users may find useful. Further, embodiments of the invention provide for particularly useful and specific types of alerts that can be used for various situations that were not previously contemplated (e.g., cash back type alerts). All such embodiments can provide broader and timelier protection against possible issues or problems that might develop for a user or a user account (e.g. detection of fraud or other unauthorized use).

It is also noted that the alert types and alert triggers that are specified above may be selected by a consumer, and the selected alert types and triggers may be stored in a database accessible to a notification server computer. The selection of such alert types and alert triggers may be conducted using a client computer operated by the consumer.

It should be understood that embodiments of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such non-transitory computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. For example, any of the above described alert triggers may be combined with any other suitable alert triggers in any suitable manner in methods or systems according to embodiments of the invention. As an illustration, a consumer may specify that he or she would like to alerts with specific sounds or ringtones, tip alerts, and specific types of SKU and item identifier types of alerts, but not other types of alerts. Thus, although specific sounds or ringtones, tip alerts, and specific types of SKU and item identifier types of alerts are separately described in this application, they may be combined in certain embodiments of the invention.

A recitation of “a”, “an” or “the” is intended to mean “one or more” unless specifically indicated to the contrary.

What is claimed is:

1. A method for detecting triggering events for initiating user account alert messages using a notification server, the method comprising:
observing a user account event at the notification server;
identifying a user account associated with the user account event using the notification server;
comparing the observed user account event with a plurality of prior user account events associated with the identified user account using the notification server; and
determining if the user account event is a triggering event based on the comparison of the observed user account event and the plurality of prior user account events.

2. The method of claim 1 wherein comparing the observed user account event with the prior user account events comprises determining an alert threshold value for a user event type associated with the observed user account event based on the plurality of prior user account events and comparing a value associated with the observed user account event with the alert threshold value.

3. A computer readable medium storing commands for causing a processor to implement the method of claim 2.

4. The method of claim 1 wherein comparing the observed user account event with the prior user account events comprises determining whether the observed user account event is consistent with the prior user account events based on a user account profile or trend.

5. The method of claim 4 wherein the user account profile or trend comprises a determination of user events per time period.

6. The method of claim 5 wherein the determination of user account events per time period comprises a distance between locations associated with one or more prior user account events.

7. The method of claim 4 wherein the user account profile or trend comprises a user account classification.

8. The method of claim 7 wherein the user account type classification is based on the prior user account events or a characteristic of a user associated with the user account.

9. The method of claim 8 wherein the prior user account events comprise a plurality of associated merchant types.

10. The method of claim 8 wherein the prior user account events comprise a plurality of associated user account event types.

11. The method of claim 8 wherein the prior user account events comprise a plurality of associated user account event locations.

12. The method of claim 8 wherein the characteristic of a user associated with the user account comprise an age associated with the user, user classification associated with the user or a home region associated with the user.

13. The method of claim 4 wherein the user account profile or trend comprises a list of previously or regularly visited merchants or merchant types.

14. The method of claim 4 wherein the user account profile or trend comprises a list of expected or acceptable user account event locations.

15. A method for detecting triggering events for initiating user account alert messages using a notification server, the method comprising:
observing a user account event at the notification server;
identifying a user account associated with the user account event using the notification server;
comparing the observed user account event with a plurality of predefined triggering user account events associated with the identified user account or a user account issuer using the notification server; and
determining if the user account event is a triggering event based on the comparison of the observed user account events and the plurality of predefined triggering user account events using the notification server,
wherein the plurality of predefined triggering user account events comprises at least one selected from the group consisting of:
a triggering event based on a difference in time and location between the observed user account event and a previously observed user account event;
a safety zone alert triggering event,
an item identifier alert triggering event,
a declined user account alert triggering event;
a privacy alert triggering event;
a new device alert triggering event; and
an unlikely merchant alert triggering event.

16. The method of claim 15 wherein the user account is associated with a principal user and a plurality of subordinate users and wherein the plurality of predefined triggering user account events comprises a first list of predefined triggering user account events associated with the principal user and a second list of predefined triggering user account events associated with the subordinate users.

17. The method of claim 15 wherein the plurality of predefined triggering user account events is determined by the notification engine.

18. The method of claim 15 wherein the plurality of predefined triggering user account events is determined by the one or more user account issuers associated with the user account.

19. The method of claim 15 wherein the triggering even based on a difference in time and location between the observed user account event and a previously observed user account event comprises a threshold value for the difference in time and location.

20. The method of claim 19 wherein the threshold value for the difference in time and location is set by an account issuer or the notification engine.

21. The method of claim 19 wherein the threshold value for the difference in time and location is based on a set of physical travel limitations.

22. The method of claim 15 wherein the safety zone alert triggering event comprises a list of addresses or zip codes.

23. The method of claim 15 wherein the safety zone alert triggering event comprises a definition of high crime areas or high fraud areas.

24. The method of claim 23 wherein the definition of the high crime areas is based on a law enforcement agency report or a law enforcement database.

25. The method of claim 23 wherein the definition of the high fraud areas is based on a law enforcement agency report, a law enforcement database or a fraud database.

26. The method of claim 15 wherein the item identifier alert triggering event comprises a list of prohibited product identifiers or prohibited service identifiers.

27. The method of claim 26 wherein the list of prohibited product identifiers or prohibited service identifiers is based on the age of one or more users associated with user account.

28. The method of claim 15 wherein the declined user account alert triggering event comprises a definition of a deactivated user account.

29. The method of claim 15 wherein the privacy alert triggering event comprises a definition of an identification verification request.

30. The method of claim 15 wherein the privacy alert triggering event comprises a definition of an address verification request.

31. The method of claim 15 wherein the new device alert triggering event comprises the definition of a newly activated credit card or mobile telephone event.

32. The method of claim 15 wherein the unlikely merchant alert triggering event comprises a list of previously observed merchants.

33. The method of claim 15 wherein the unlikely merchant alert triggering event comprises a list of unlikely merchant or merchant types based on a characteristic of a user associated with the user account.

34. A computer readable medium storing commands for causing a processor to implement the method of claim 15.

35. A server computer comprising the processor and the computer readable medium of claim 34 coupled to the processor.

36. A server computer comprising the processor and the computer readable medium of claim 3 coupled to the processor.
or a list of item identifiers or item type identifiers that are prohibited for the user account associated with the observed user account event.

37. A method comprising:
sending by an access device an authorization request message to an issuer via a payment processing network comprising a server computer, wherein the server computer (i) observes a user account event at the notification server after receiving the authorization request message, (ii) identifies a user account associated with the user account event using the notification server, (iii) compares the observed user account event with a plurality of prior user account events associated with the identified user account using the notification server; (iv) and determines if the user account event is a triggering event based on the comparison of the observed user account event and the plurality of prior user account events; and
receiving an authorization request message from the payment processing network.

38. A method comprising:
sending by an access device an authorization request message to an issuer via a payment processing network comprising a server computer, wherein the server computer (i) observes a user account event at the notification server; (ii) identifies a user account associated with the user account event using the notification server, (iii) compares the observed user account event with a plurality of predefined triggering user account events associated with the identified user account or a user account issuer using the notification server, and (iv) determines if the user account event is a triggering event based on the comparison of the observed user account events and the plurality of predefined triggering user account events using the notification server, wherein the plurality of predefined triggering user account events comprises at least one selected from the group consisting of a triggering event based on a difference in time and location between the observed user account event and a previously observed user account event, a safety zone alert triggering event, or an item identifier alert triggering event, a declined user account alert triggering event, a privacy alert triggering event, a new device alert triggering event, and an unlikely merchant alert triggering event; and receiving an authorization request message from the payment processing network.
